(19) United States
(12) Patent Application Publication
(10) Pub. No.: US 2018/0282483 A1
(43) Pub. Date: Oct. 4, 2018

(54) Polyarylene ether sulfone (PAES) Polymers and Methods for Making the Same

(71) Applicant: SOLVAY SPECIALTY POLYMERS USA, LLC

(72) Inventors: Chantal LOUIS, Alpharetta, GA (US); David CHAPON, Mont-Saint-Guibert (BE)

(73) Assignee: SOLVAY SPECIALTY POLYMERS USA, LLC, Alpharetta, GA (US)

(21) Appl. No.: 15/524,417

(22) PCT Filed: Oct. 15, 2015
(86) PCT No.: PCT/EP2015/073835

§ 371 Date: May 4, 2017

Related U.S. Application Data
(60) Provisional application No. 62/076,694, filed on Nov. 7, 2014.

(51) Int. Cl. C08G 75/23

(52) U.S. Cl. CPC C08G 75/23

(57) ABSTRACT

A poly(arylether sulfone)polymer[(t-PAES)polymer], wherein more than 70% moles of the recurring units are recurring units (R₁) of formula (St): -E-Ar₁—SO₂—[Ar₂-(T-Ar₃)ₙ-SO₂]m-Ar₄— (formula Sₜ) wherein: n and m, equal to or different from each other, are independently zero or an integer ranging from 1 to 5, each of Ar1, Ar2, Ar3 and Ar4 equal to or different from each other, is an aromatic moiety, T is a bond or a divalent group optionally comprising one or more than one heteroatom; -E is of formula (Eₜ): wherein each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine,and a quaternary ammonium; j′ is zero or an integer ranging from 1 to 4,and further wherein the (t-PAES) polymer exhibits a ¹H NMR signal at from about 8.1 to about 8.3 ppm of <1.

### CROSS-REFERENCE TO RELATED APPLICATION

The present application claims priority to U.S. Provisional Application No. 62/076,694, which is incorporated by reference herein in its entirety.

### FIELD OF THE INVENTION

The present invention relates to polyarylene ether sulfone (PAES) polymers comprising moieties derived from incorporation of 4,4″-terphenyl-p-diol exhibiting high melt stability, and processes for the manufacture of said polyarylene ether sulfone (PAES) polymers.

### BACKGROUND

The selection of polymeric material in more demanding, corrosive, harsh chemical, high-pressure and high-temperature (HP/HT) environments, such as notably in oil and gas downhole applications, in particular in deep see oil wells, is of ultimate importance as it implies that said polymeric materials need to possess some critical properties in order to resist the extreme conditions associated with said environments.

It should be mentioned that in these extreme conditions the polymeric materials are exposed in a prolonged fashion to high pressure, e.g. pressures higher than 30,000 psi, high temperatures, e.g. temperatures up to 260° C., and to harsh chemicals including acids, bases, superheated water/steam, and of course a wide variety of aliphatic and aromatic organics. For example, enhanced oil recovery techniques involve injecting of fluids such as notably water, steam, hydrogen sulfide (H₂S) or supercritical carbon dioxide (sCO₂) into the well. In particular, sCO₂ having a solvating effect similar to n-heptane, can cause swelling of materials in for instance seals, which affect consequently their performance. Polymeric materials having glass transition temperatures (Tg) too low relative to the high temperature in HP/HT applications will suffer from being weak and susceptible to high creep in these HP/HT applications. This creep can cause the seal material made of said polymeric material to no longer effectively seal after prolonged exposure at temperature which are 20 or more ° C. above their Tg.

Thus, properties such as maintaining mechanical rigidity and integrity (e.g. tensile strength and modulus, hardness and impact toughness) at high pressure and temperatures of at least 250° C., good chemical resistance, in particular when exposed to CO₂, H₂S, amines and other chemicals at said high pressure and temperature, swelling and shrinking by gas and by liquid absorption, decompression resistance in high pressure oil/gas systems, gas and liquid diffusion and long term thermal stability need to be considered in the selection of appropriate polymeric materials for HP/HT applications.

Thus, there is a need for polymeric materials that possess, for example, high melt stability and resistance to swelling in HP/HT applications.

Because polymeric materials may have high melting temperatures (Tm), they may be processed at high temperatures. Therefore high melt stability is desirable. Polymeric materials lacking melt stability may exhibit a lower degree of crystallinity after processing, which may reduce their chemical resistance.

### SUMMARY OF THE INVENTION

It has surprisingly and unexpectedly been discovered that certain poly(arylether sulfone) polymers exhibiting a high melt stability can be prepared by following a particular order of addition of raw materials during the polymerization reaction. For example, a polymer having a high melt stability may be prepared by forming a premix including at least one alkali metal carbonate and at least one dihydroxyaryl in at least one polar aprotic solvent followed by the slow or stepwise addition of at least one dihaloaryl compound to the reaction mixture at a temperature of about 200° C. to about 320° C. (220° C. preferred).

The polymerization reaction also preferably includes a step to end-cap the polymer with inert end groups, for example, by adding an excess of the dihaloaryl compound at the end of the reaction.

Polymers made by the methods of the invention have unexpectedly been found to exhibit one or more of:
For a given molecular weight, increased degree of crystallinity and higher melting temperature (Tm);
A stable melt viscosity as measured by dynamic rheology (parallel plates) at 420° C., 10 rad/s for 40 minutes (no swelling of sample, viscosity ratio VR40 ≤1.40); and
The absence of any signal in ¹H NMR at about 8.2 ppm (relative integration result <0.1).

Without being bound by the theory, it is believed that the methods of the invention produce a particular polymer architecture/microstructure which give the polymer a high melt stability. Although the particular microstructure/architecture has not yet been determined, it has unexpectedly been observed that the intensity of the ¹H NMR at about 8.2 ppm, which is otherwise present in ¹H NMR spectra of similar polymers prepared by comparative methods, is significantly reduced or absent in polymers prepared according the methods of the invention.

Exemplary embodiments are directed to a method for making a poly(arylether sulfone) polymer [(t-PAES) polymer], including:
a) forming a premix including:
   at least one polar aprotic solvent;
   at least one alkali metal carbonate, and
   at least one dihydroxyaryl compound [diol (AA)] of Formula (T):

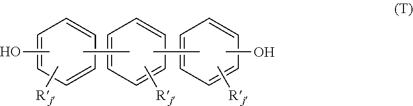

wherein:
each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
j′ is zero or an integer ranging from 1 to 4; and
b) reacting the premix with at least one dihaloaryl compound [dihalo(BB)] of Formula (S):

X—Ar¹—SO₂—[Ar²-(T-Ar³)ₙ—SO₂]ₘ—Ar⁴—X′ (S)
wherein:
   n and m, equal to or different from each other, are independently zero or an integer ranging from 1 to 5;
   X and X′ are independently selected from F, Cl, Br, and I;
   each of Ar¹, Ar², Ar³ and Ar^{4,} equal to or different from each other, is an aromatic moiety; and
   T in Formula (S) is selected from a bond, —CH₂—, —C(O)—, —C(CH₃)₂—, —C(CF₃)₂—, —C(═CCl₂)—, —C(CH₃)(CH₂CH₂COOH)—, and a group of formula:

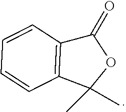

The premix may additionally include at least one dihydroxyaryl compound [diol (A′A′)] different from diol (AA).

The method may further include reacting the premix with at least one dihaloaryl compound [dihalo (B′B′)] different from dihalo (BB).

The diol (A′A′) may be selected from compounds of Formula (D):

HO—Ar⁹-(T′-Ar-¹⁰)ₙ—O—H (D)
wherein:
   n is zero or an integer ranging from 1 to 5;
   each of Ar⁹ and Ar¹⁰, equal to or different from each other, is an aromatic moiety of formula:

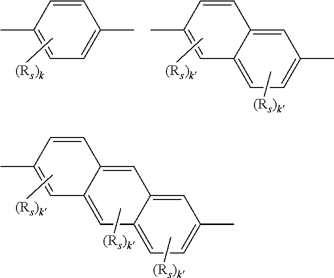

wherein:
   each Rₛ is independently selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
   k is zero or an integer ranging from 1 to 4; and
   k′ is zero or an integer ranging from 1 to 3; and
   T′ is selected from a bond, —SO₂—, —CH₂—, —C(O)—, —C(CH₃)₂—, —C(CF₃)₂—, —C(═CCl₂)—, —C(CH₃)(CH₂CH₂COOH)—, and a group of formula:

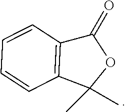

The dihalo (B′B′) may be a compound of Formula (K):

X—Ar⁵—CO—[Ar⁶-(T-Ar⁷)ₙ—CO]ₘ—Ar⁸—X′ (K)
wherein:
   n and m, equal to or different from each other, are independently zero or an integer ranging from 1 to 5,
   each of Ar⁵, Ar⁶, Ar⁷ and Ar⁸, equal to or different from each other, is an aromatic moiety,
   T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

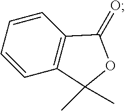

and
X and X′ are independently selected from F, Cl, Br, or I.

In step b), a total amount by weight of the at least one dihaloaryl compound [dihalo(BB)] and the at least one dihydroxyaryl compound [diol (AA)] may be equal to or greater than 22% and less than or equal to 50% of the combined weight of the at least one dihaloaryl compound [dihalo(BB)], the at least one dihydroxyaryl compound [diol (AA)], and the at least one solvent.

Reacting the premix with the at least one dihaloaryl compound [dihalo(BB)] may include forming monomer mixture, and an overall amount of halo-groups and hydroxyl-groups in the monomer mixture may be substantially equimolecular.

The method may further include a step c) of end-caping the (t-PAES) polymer by adding an additional amount of the dihaloaryl compound [dihalo(BB)] in molecular excess.

The at least one alkali metal carbonate may include at least 50% by weight of sodium carbonate.

The premix is may be free or substantially free of potassium hydroxide (KOH).

The (t-PAES) polymer may have a number average molecular weight (Mₙ) of at least 25,000 g/mol.

The (t-PAES) polymer may have a ¹H NMR signal from about 8.1 ppm to about 8.3 ppm of ≤1, preferably ≤0.6. Most preferably, the (t-PAES) polymer does not exhibit an ¹H NMR signal at from about 8.1 ppm to about 8.3 ppm.

The (t-PAES) polymer may have a melt stability η₄₀/η₁₀ ranging from about 0.9 to about 1.40.

The (t-PAES) polymer may have a high melt stability and a melting temperature (Tm) greater than or equal to 370° C.

Exemplary embodiments include a (t-PAES) polymer made by a method of the invention.

Exemplary embodiments include a poly(arylether sulfone) polymer [(t-PAES) polymer] comprising recurring units (Rₜ) of formula (Sₜ):

-E-Ar¹—SO₂—[Ar²-(T-Ar³)ₙSO₂]ₘ—Ar⁴— (Sₜ)
wherein:
   n and m, equal to or different from each other, are independently zero or an integer ranging from 1 to 5,
   each of Ar¹, Ar², Ar³ and Ar⁴, equal to or different from each other, is an aromatic moiety,
   T is a bond or a divalent group optionally comprising one or more than one heteroatom; preferably T is selected from a bond,
   —CH₂—, —C(O)—, —C(CH₃)₂—, —C(CF₃)₂—, —C(═CCl₂)—, —C(CH₃)(CH₂CH₂COOH)—, and a group of formula:

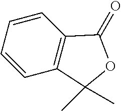

E is a group of formula (Eₜ):

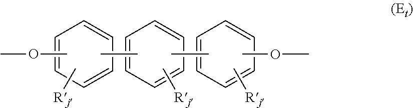

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
   j′ is zero or is an integer ranging from 1 to 4, and
further wherein the (t-PAES) polymer exhibits a ¹H NMR signal at from about 8.1 ppm to about 8.3 ppm of <1.

The recurring units (Rₜ) may be selected from recurring units of formula (Sₜ-1) to (Sₜ-4):

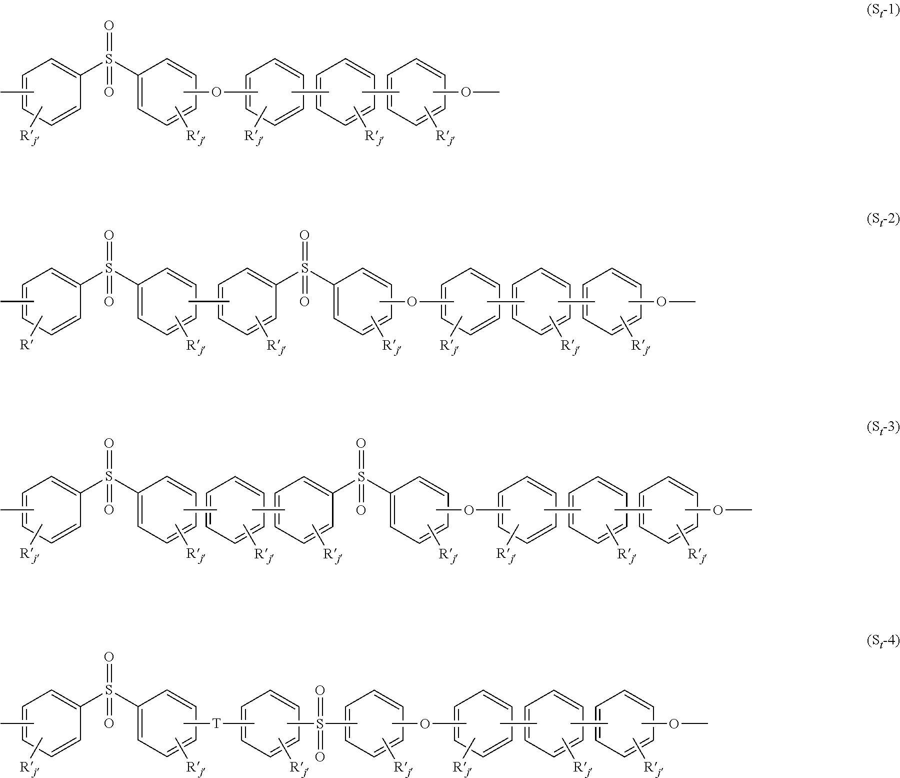

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
   j′ is zero or an integer ranging from 1 to 4,
   T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

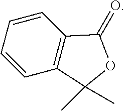

The (t-PAES) polymer may additionally include recurring units (Rₐ) of Formula (Kₐ):

-E-Ar⁵—CO—[Ar⁶-(T-Ar⁷)ₙ—CO]ₘ—Ar⁸— (Kₐ)
wherein:
   n and m, equal to or different from each other, are independently zero or an integer ranging from 1 to 5,
   each of Ar⁵, Ar⁶, Ar⁷ and Ar⁸equal to or different from each other, is an aromatic moiety,
   T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

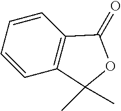

E is of formula (Eₜ):

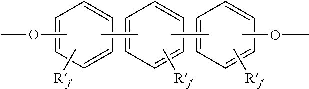

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium.

The (t-PAES) polymer may additionally include recurring units (R_{b}) of Formula (S1):

—Ar⁹-(T′-Ar¹⁰)ₙ—O—Ar¹¹—SO₂—[Ar¹²-(T-Ar¹³)ₙ—SO₂]ₘ—Ar¹⁴—O— (S1)
wherein:

Ar⁹, Ar¹⁰, Ar¹¹, Ar¹², Ar¹³ and Ar¹⁴, equal to or different from each other, are independently an aromatic mono- or polynuclear group;
T and T′, equal to or different from each other, are independently selected from a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

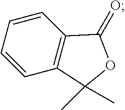

and
n and m, equal to or different from each other, are independently zero or an integer ranging from 1 to 5.

The (t-PAES) polymer may additionally include recurring units (R_{c}) selected from:

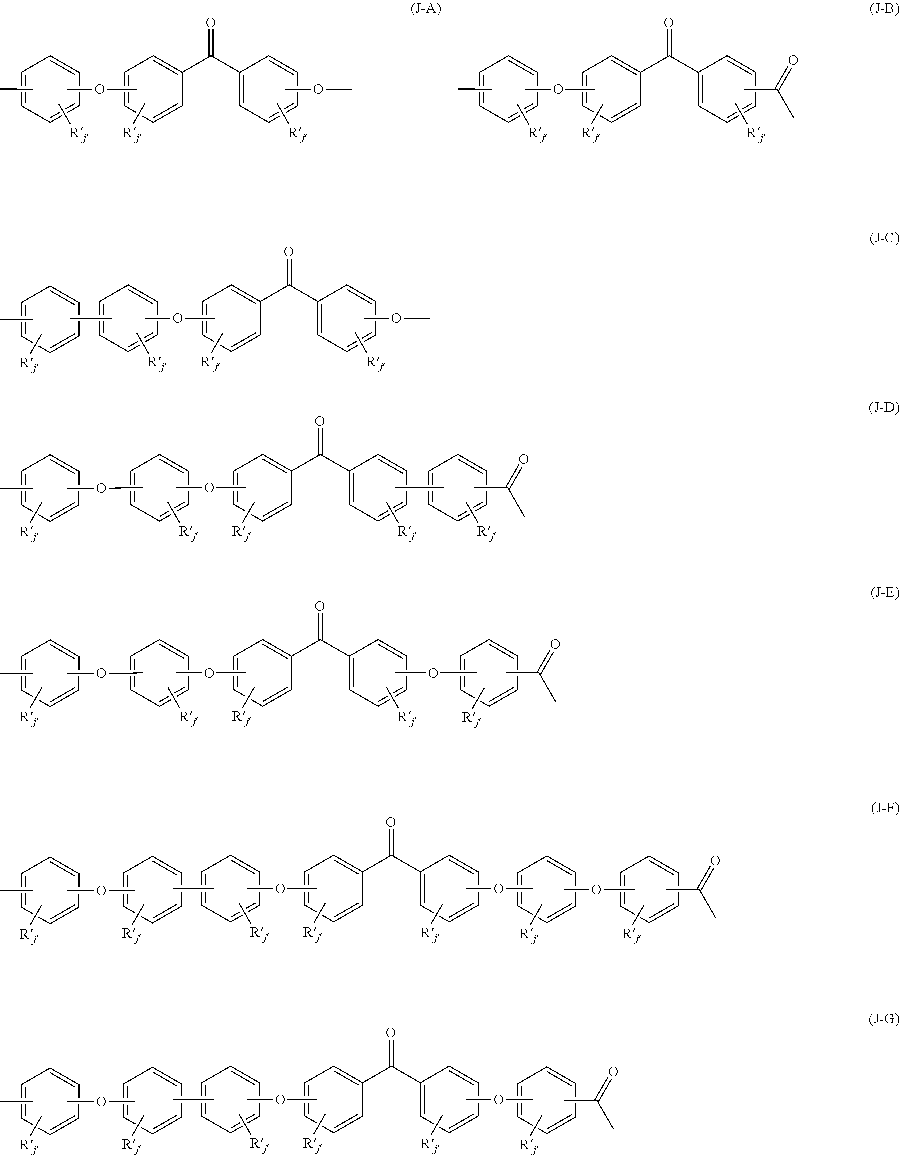

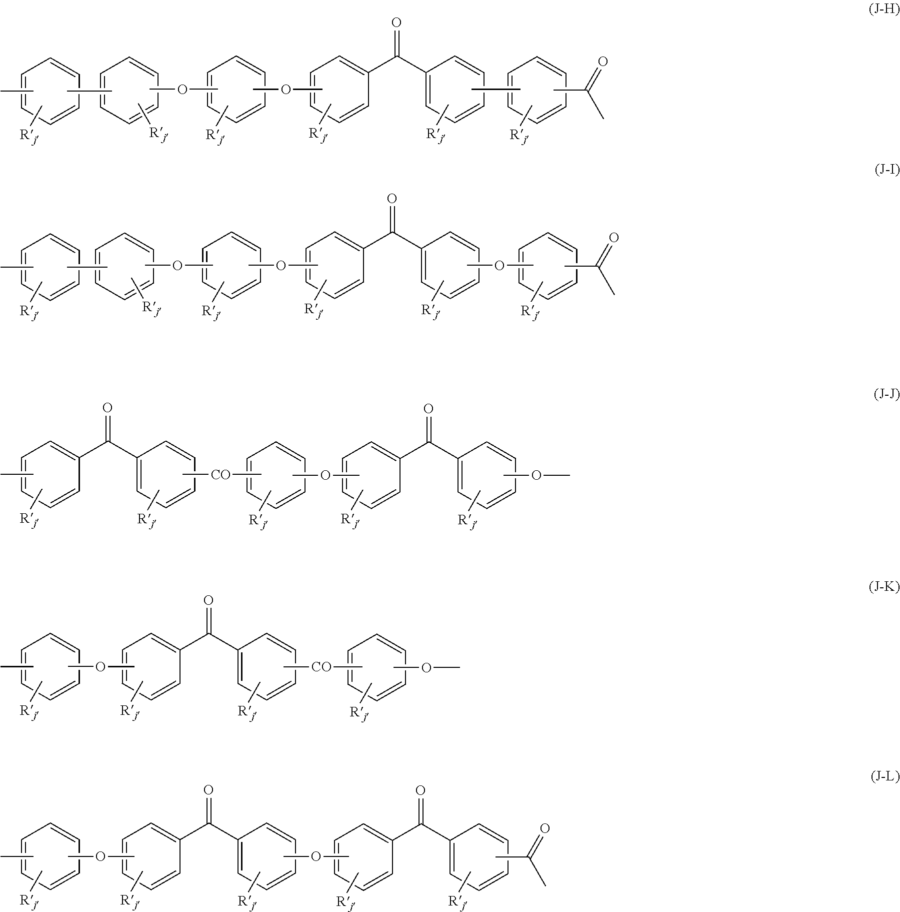

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
   j′ is zero or is an integer from 0 to 4.

The (t-PAES) polymer may have a number average molecular weight (Mₙ) ranging from 25,000 to 90,000 g/mol.

The (t-PAES) polymer may have a polydispersity index of less than or equal to 4.0.

The (t-PAES) polymer may have a melt stability η₄₀/η₁₀ ranging from about 0.9 to about 1.40.

Exemplary embodiments include a shaped article including the (t-PAES) polymer of the invention.

Exemplary embodiments include a method for making a shaped article including injection moulding, extrusion moulding, or compression moulding the (t-AES) polymer of the invention.

Exemplary embodiments include a method for making a shaped article including injection moulding, extrusion moulding, or compression moulding a (t-PAES) polymer prepared by the method of the invention.

Exemplary embodiments include a composition including the (t-PAES) of the invention, optionally with one or more additional ingredients.

Exemplary embodiments include a composition including the (t-PAES) polymer prepared by the method of the invention, optionally with one or more additional ingredients.

### BRIEF DESCRIPTION OF THE FIGURES

FIG. 1A illustrates a 1H NMR spectrum for the (t-PAES) polymer of Example C1.

FIG. 1B illustrates a 1H NMR spectrum for the (t-PAES) polymer of Example C2.

FIG. 1C illustrates a 1H NMR spectrum for the (t-PAES) polymer of Example C3.

FIG. 2A illustrates a 1H NMR spectrum for the (t-PAES) polymer of Example 4.

FIG. 2B illustrates a 1H NMR spectrum for the (t-PAES) polymer of Example 5.

FIG. 2C illustrates a 1H NMR spectrum for the (t-PAES) polymer of Example 6.

### DETAILED DESCRIPTION OF PREFERRED EMBODIMENTS

The Applicant has now found that it is possible to advantageously manufacture polyarylene ether sulfone (PAES) polymers comprising moieties derived from incorporation of 4,4″-terphenyl-p-diol wherein said (PAES) polymers have controlled high molecular weights, maintain mechanical rigidity and integrity, maintain an adequate crystallinity, have good chemical resistance, and have improved melt stability at high pressure and temperature.

The (t-PAES) Polymer

Exemplary embodiments are directed to a poly(arylether sulfone) polymer [(t-PAES) polymer], including recurring units (Rₜ) of formula (Sₜ):

-E-Ar¹—SO₂—[Ar²-(T-Ar³)ₙ—SO₂]ₘ—Ar⁴— (Sₜ)
wherein:
   n and m, equal to or different from each other, are independently zero or an integer ranging from 1 to 5,
   each of Ar¹, Ar², Ar³ and Ar⁴ equal to or different from each other, is an aromatic moiety,
   T is a bond or a divalent group optionally comprising one or more than one heteroatom; preferably T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

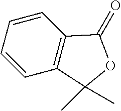

E is of formula (Eₜ):

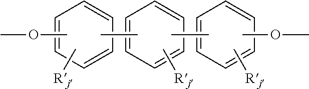

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
   j′ is zero or an integer ranging from 1 to 4.

The (t-PAES) polymer may exhibit a ¹H NMR signal in the range about 8.1 ppm to about 8.3 ppm, preferably, about 8.1 ppm to about 8.25 ppm, preferably about 8.1 ppm to about 8.2 ppm. The intensity of this signal can be estimated by integrating the NMR signal from the baseline between 8.1 and 8.3 ppm. The relative intensity can be calculated using the formula:

% relative signal 8.2ppm=[Integral (signal at 8.2 ppm)×24(═ΣH⁺OMCTS)×weight (OMCTS)]/[Integral (OMCTS at 0.2 ppm)×weight (sample)×concentration (polymer % weight in pentafluorophenol)×MW(OMCTS)]*1000

The intensity of the of the ¹H NMR signal is preferably ≤1, preferably ≤0.9, preferably ≤0.8, preferably ≤0.7, preferably ≤0.6, preferably ≤0.5, preferably ≤0.4, preferably ≤0.3, preferably ≤0.2, preferably ≤0.1, preferably zero or substantially zero.

A person of ordinary skill in the art will recognize that additional chemical shift ranges within the explicitly disclosed ranges are contemplated and within the scope of the present disclosure as necessary to define a given ¹H NMR signal.

The (t-PAES) polymer preferably also possesses one or more of a high Tg, high stiffness and strength, high toughness, high percent crystallization, high melt stability and good chemical resistance.

The aromatic moiety in each of Ar¹, Ar², Ar³ and Ar⁴ equal to or different from each other and at each occurrence is preferably at least one group of following formulae:

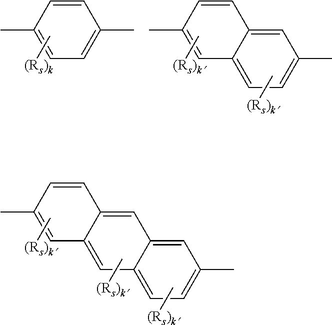

wherein:
   each Rₛ is independently selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
   k is zero or an integer ranging from 1 to 4; k′ is zero or an integer ranging from 1 to 3.

In recurring unit (Rₜ), the respective phenylene moieties may independently have 1,2-, 1,4- or 1,3-linkages to the other moieties different from R or R′ in the recurring unit. Preferably, said phenylene moieties have 1,3- or 1,4-linkages, more preferably they have a 1,4-linkage.

Still, in recurring units (Rₜ), j′, k′ and k are at each occurrence zero, that is to say that the phenylene moieties have no other substituents than those enabling linkage in the main chain of the polymer.

Preferred recurring units (Rₜ) are selected from those of formula (Sₜ-1) to (Sₜ-4) herein below:

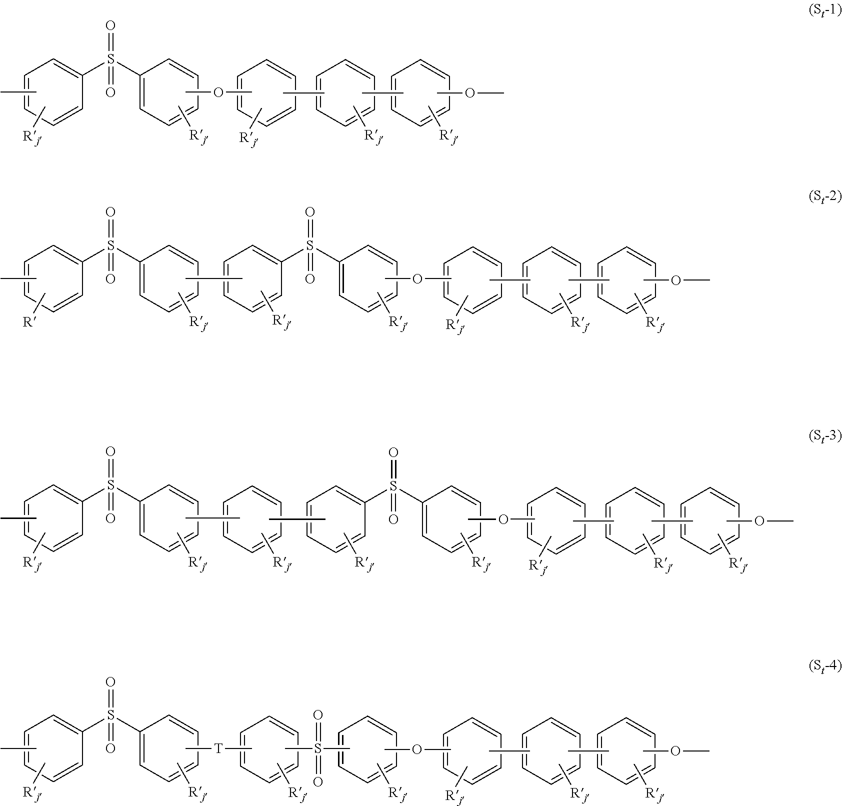

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
   j′ is zero or an integer ranging from 1 to 4,
   T is a bond or a divalent group optionally comprising one or more than one heteroatom; preferably T is selected from a bond,
   —CH₂—, —C(O)—, —C(CH₃)₂—, —C(CF₃)₂—, —C(═CCl₂)—, —C(CH₃)(CH₂CH₂COOH)—, and a group of formula:

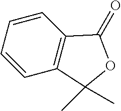

The above recurring units of preferred embodiments (Rₜ-1) to (Rₜ-4) can be each present alone or in admixture.

More preferred recurring units (Rₜ) are selected from those of formula (S′ₜ-1) to (S′ₜ-3) herein below:

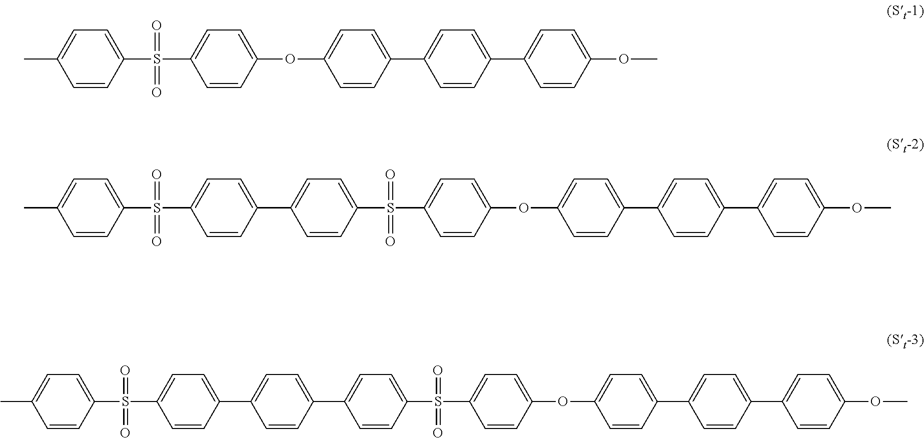

Preferably, recurring unit (Rₜ) is of formula (S′ₜ-1), as shown above. According to certain embodiments, the (t-PAES) polymer, as detailed above, comprises in addition to recurring units (Rₜ), as detailed above, recurring units (Rₐ) of formula (Kₐ):

-E-Ar⁵—CO—[Ar⁶-(T-Ar⁷)ₙ—CO]ₘ—Ar⁸— (formula Kₐ)
wherein:
   n and m, equal to or different from each other, are independently zero or an integer ranging from 1 to 5,
   each of Ar⁵, Ar⁶, Ar⁷ and Ar⁸ equal to or different from each other, is an aromatic moiety,
   T is a bond or a divalent group optionally comprising one or more than one heteroatom; preferably T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

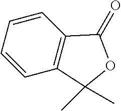

E is of formula (Eₜ), as detailed above.

Recurring units (Rₐ) can notably be selected from those of formulae (Kₐ-1) or (Kₐ-2) herein below:

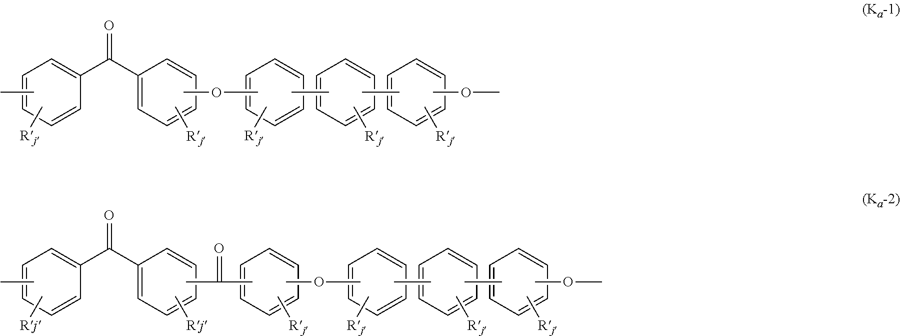

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
   j′ is zero or an integer ranging from 1 to 4.

More preferred recurring units (Rₐ) are selected from those of formula (K′ₐ-1) or (K′ₐ-2) herein below:

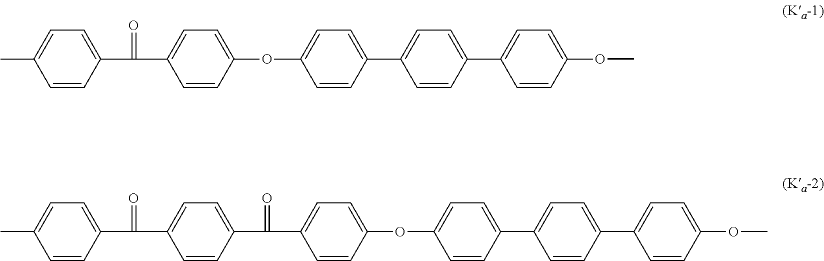

According to certain embodiments, the (t-PAES) polymer, as detailed above, comprises in addition to recurring units (Rₜ), as detailed above, recurring units (R_{b}) comprising a Ar—SO₂—Ar′ group, with Ar and Ar′, equal to or different from each other, being aromatic groups, said recurring units (R_{b}) generally complying with formulae (S1):

—Ar⁹-(T′-Ar¹⁰)ₙ—O—Ar¹¹—SO₂—[Ar¹²-(T-Ar¹³)ₙ—SO₂]ₘ—Ar¹⁴—O— (S1):
wherein:

Ar⁹, Ar¹⁰, Ar¹¹, Ar¹², Ar¹³ and Ar¹⁴, equal to or different from each other and at each occurrence, are independently an aromatic mono- or a polynuclear group;
T and T′, equal to or different from each other, is independently a bond or a divalent group optionally comprising one or more than one heteroatom; preferably T′ is selected from a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

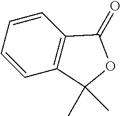

preferably T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

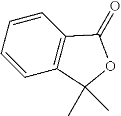

n and m, equal to or different from each other, are independently zero or an integer ranging from 1 to 5;

Recurring units (R_{b}) may be notably selected from those of formulae (S1-A) to (S1-D) herein below:

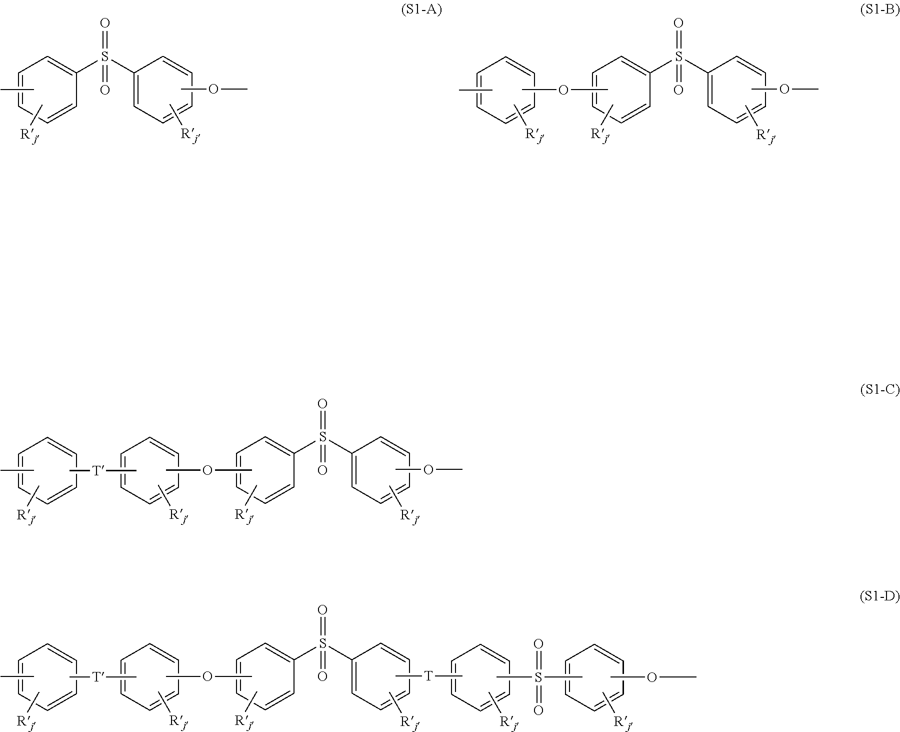

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
   j′ is zero or is an integer from 0 to 4;
   T and T′, equal to or different from each other are a bond or a divalent group optionally comprising one or more than one heteroatom; preferably T′ is selected from a bond, —CH₂—, —C(O)—, —C(CH₃)₂—, —C(CF₃)₂—, —C(═CCl₂)—, C(CH₃)(CH₂CH₂COOH)—, —SO₂—, and a group of formula:

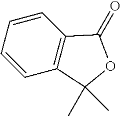

preferably T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

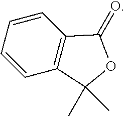

In recurring unit (R_{b}), the respective phenylene moieties may independently have 1,2-, 1,4- or 1,3-linkages to the other moieties different from R′ in the recurring unit. Preferably, said phenylene moieties have 1,3- or 1,4- linkages, more preferably they have 1,4-linkages. Preferably, in recurring units (R_{b}), j′ is at each occurrence zero, that is to say that the phenylene moieties have no other substituents than those enabling linkage in the main chain of the polymer.

According to certain embodiments, the (t-PAES) polymer, as detailed above, comprises in addition to recurring units (Rₜ), as detailed above, recurring units (R_{c}) comprising a Ar—C(O)—Ar′ group, with Ar and Ar′, equal to or different from each other, being aromatic groups, said recurring units (R_{c}) being generally selected from formulae (J-A) to (J-L), herein below:

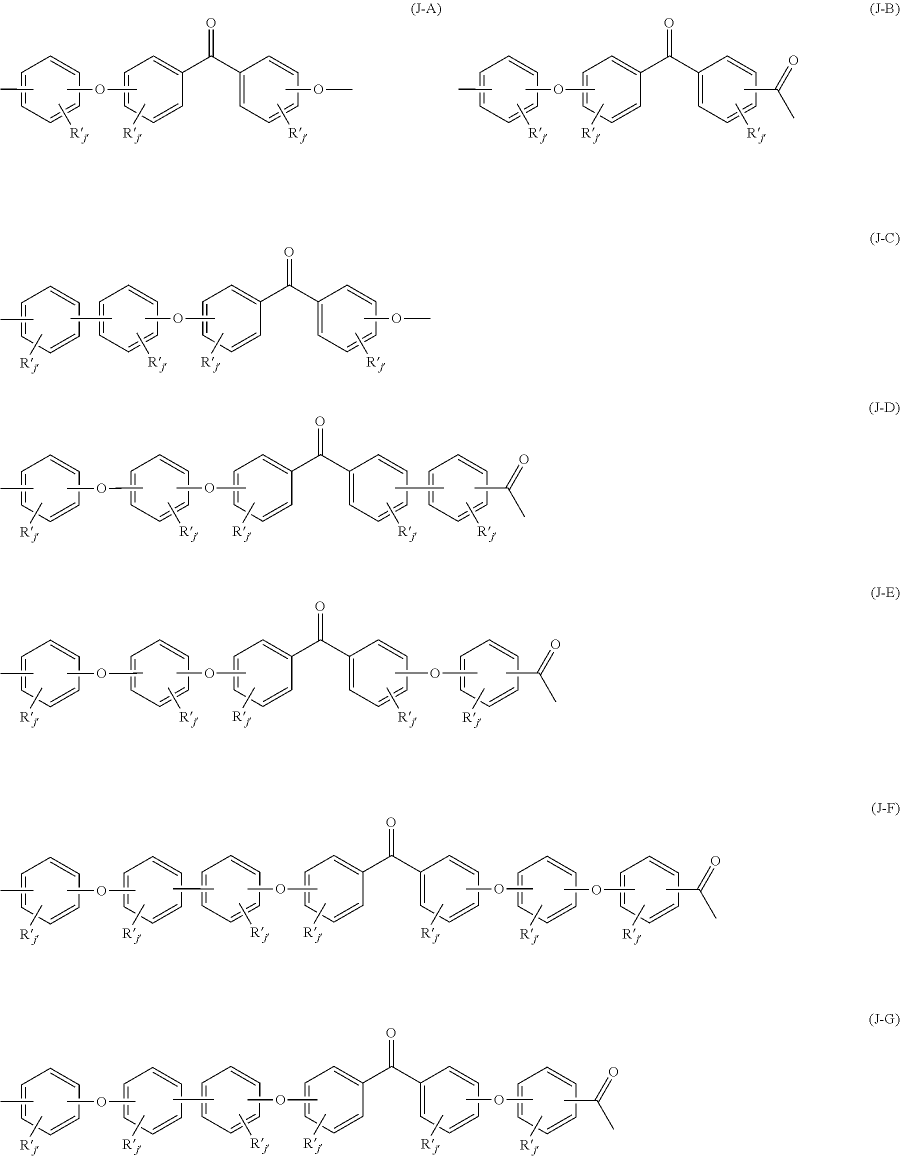

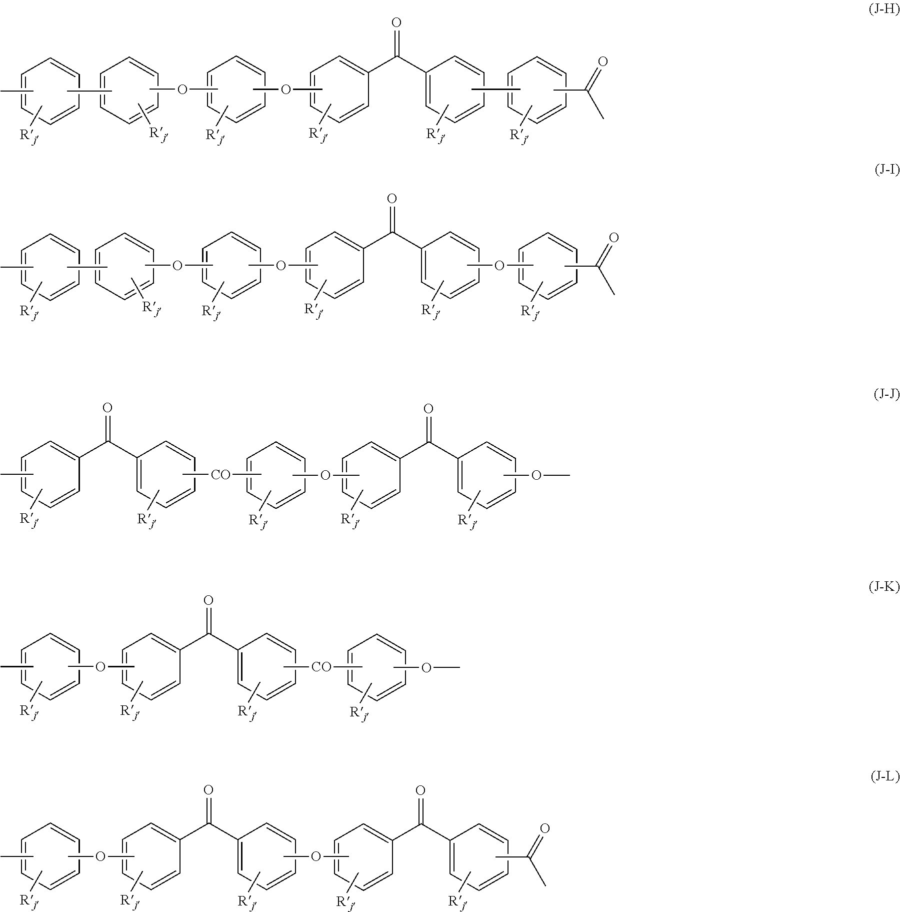

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
   j′ is zero or is an integer from 0 to 4.

In recurring unit (R_{c}), the respective phenylene moieties may independently have 1,2-, 1,4- or 1,3-linkages to the other moieties different from R′ in the recurring unit. Preferably, said phenylene moieties have 1,3- or 1,4- linkages, more preferably they have 1,4-linkage.

Preferably, in recurring units (R_{c}), j′ is at each occurrence zero, that is to say that the phenylene moieties have no other substituents than those enabling linkage in the main chain of the polymer.

The (t-PAES) polymer preferably comprises recurring units (Rₜ) of formula (Sₜ) as above detailed in an amount of more than 50% moles, preferably more than 60%, preferably more than 70% moles, preferably more than 75% moles, preferably more than 85% moles, preferably more than 90% moles, preferably more than 90% moles, preferably 100% or essentially 100%, any complement to 100% moles being generally recurring units (Rₐ), as above detailed, and/or recurring units (R_{b}), and/or recurring units (R_{c}), as above detailed.

Still more preferably, essentially all the recurring units of the (t-PAES) polymer are recurring units (Rₜ), chain defects, or very minor amounts of other units might be present, being understood that these latter do not substantially modify the properties of the (t-PAES) polymer. Most preferably, all the recurring units of the (t-PAES) polymer are recurring units (Rₜ). Excellent results are obtained when the (t-PAES) polymer was a polymer of which all the recurring units are recurring units (Rₜ), as above detailed.

Preferably, the (t-PAES) polymer is suitable for use in HP/HT applications, in particular in oil and gas downhole operations.

The (t-PAES) polymer of the invention advantageously has a number average weight (Mₙ) ranging from about 25,000 to about 90,000 g/mol, preferably from about 29,000 to about 85,000 g/mol, preferably from about 41,000 to about 85,000 g/mol, preferably from about 43,000 to about 80,000 g/mol, preferably from about 45,000 to about 80,000 g/mol.

A person of ordinary skill in the art will recognize additional molecular weight ranges within the explicitly disclosed ranges are contemplated and within the scope of the present disclosure.

In exemplary embodiments, the (t-PAES) polymer has a number average molecular weight (Mₙ) equal to or less than about 90,000 g/mol, preferably equal to or less than about 85,000 g/mol, preferably equal to or less than about 80,000 g/mol, preferably equal to or less than about 75,000 g/mol.

In exemplary embodiments, the (t-PAES) polymer has a number average molecular weight (Mₙ) equal to or greater than about 25,000 g/mol, preferably equal to or greater than about 29,000 g/mol, preferably equal to or greater than about 30,000 g/mol, preferably equal to or greater than about 35,000 g/mol, preferably equal to or greater than about 40,000 g/mol, preferably equal to or greater than about 45,000 g/mol, preferably equal to or greater than 50,000 g/mol, preferably equal to or greater than about 55,000 g/mol.

The (t-PAES) polymer having such specific molecular weight (Mₙ) range have been found to possess an excellent ductility (i.e high tensile elongation), good thoughness while maintaining high Tg, good crystallizability, good chemical resistance, and high melt stability.

The number average molecular weight (Mₙ) is:

$${M}_{n} = \frac{\sum {M}_{i} \cdot {N}_{i}}{\sum {N}_{i}}$$

wherein Mᵢ is the discrete value for the molecular weight of a polymer molecule, Nᵢ is the number of polymer molecules with molecular weight Mᵢ, then the weight of all polymer molecules is ΣMᵢNᵢ and the total number of polymer molecules is ΣNᵢ.

Mₙ, can be suitably determined by gel-permeation chromatography (GPC) calibrated with polystyrene standards.

Other molecular parameters which can be notably determined by GPC are the weight average molecular weight (M_{w}):

$${M}_{w} = \frac{\sum {M}_{i}^{2} \cdot {N}_{i}}{\sum {M}_{i} \cdot {N}_{i}} ,$$

wherein Mᵢ is the discrete value for the molecular weight of a polymer molecule, Nᵢ is the number of polymer molecules with molecular weight then the weight of polymer molecules having a molecular weight Mᵢ is MᵢNᵢ.

For the purpose of the present invention, the polydispersity index (PDI) is hereby expressed as the ratio of weight average molecular weight (M_{w}) to number average molecular weight (Mₙ).

The details of the GPC measurement are described in detail in the method description given in the experimental section.

For the determination of the number average molecular weight (Mₙ) by GPC, the (t-PAES) polymer is generally dissolved in a solvent suitable for GPC providing hereby a polymer solution.

A specimen of said polymer solution or a diluted specimen can then be injected into conventional GPC equipment.

The concentration of the (t-PAES) polymer in the polymer solution [polymer concentration, herein after] is between 1.0 to 10.0 mg/ml, preferably between 1.5 to 5.0 mg/ml, more preferably between 2.0 to 3.0 mg/ml. Good results were obtained with a concentration of the (t-PAES) polymer in the polymer solution of about 2.5 mg/ml.

Preferred solvents and solvent blends suitable to dissolve the (t-PAES) polymer of the present invention for determination of the Mₙ values are for example 4-chlorophenol, 2-chlorophenol, meta-cresol. 4-chlorophenol is most preferred.

The dissolving of the (t-PAES) polymer of the present invention is advantageously carried out at a temperature from 100 to 250° C., preferably from 120 to 220° C. and more preferably from 170 to 200° C.

For the determination of the Mₙ values by GPC, N-methyl-2-pyrrolidone (NMP) containing at least one salt is suitably used as eluent.

Suitable salts for use in NMP include lithium bromide and lithium chloride. Lithium bromide is most preferred.

The molar concentration of said salt present in NMP can vary from 0.05 mole salt per liter NMP to 0.2 mole salt per liter NMP. Good results were obtained when the molar concentration of said salt present in NMP is about 0.1 mole salt per liter NMP.

In a preferred embodiment, a specimen of said polymer solution, before injecting into the GPC equipment, is further diluted by the eluent thereby providing a diluted polymer solution [polymer solution (2), herein after].

In this preferred embodiment, the concentration of the (t-PAES) polymer in the polymer solution (2) [polymer concentration (2), herein after] is between 0.05 to 0.50 mg/ml, preferably between 0.10 to 0.25 mg/ml, more preferably between 0.20 to 0.25 mg/ml. Good results were obtained with a concentration of the (t-PAES) polymer in the polymer solution (2) of about 0.25 mg/ml.

The GPC measurements are in general carried out at a temperature ranging from 20 to 50° C., preferably from 30 to 50° C., more preferably from 35 to 45° C. Good results were obtained when the temperature was about 40° C.

The GPC measurements are in general carried out at a pump flow rate from 0.3 to 0.9 ml/min, preferably from 0.5 to 0.7ml/min. Good results were obtained when the flow rate was about 0.5ml/min.

It is understood that the calibration with the polystyrene standards is carried out according to ordinary skills in the art. The details of said calibration with the polystyrene standards can be found in the experimental section below.

Another aspect of the present invention is related to the GPC measurement as described above.

The (t-PAES) polymer may have a polydispersity index (PDI) of more than 1.95, preferably more than 2.00, more preferably more than 2.05, and more preferably more than 2.10.

The (t-PAES) polymer of the present invention generally has a polydispersity index of less than or equal to 4.0, preferably of less than or equal to 3.0, more preferably of less than or equal to 2.7.

In addition, some other analytical methods can be used as an indirect method for the determination of molecular weight including notably viscosity measurements.

In one embodiment of the present invention, the (t-PAES) polymer of the present invention has a melt viscosity of advantageously at least 6.0 kPa·s, preferably at least 6.5 kPa·s, more preferably at least 7.0 kPa·s at 420° C. and a shear rate of 10 rad/sec, as measured using a parallel plates viscometer (e.g. TA ARES RDA3 model) in accordance with ASTM D4440. The (t-PAES) polymer of the present invention has a melt viscosity of advantageously of at most 25 kPa·s, preferably of at most 22 kPa·s, more preferably of at most 20 kPa·s at 420° C. and a shear rate of 10 rad/sec, as measured using a parallel plates viscometer (e.g. TA ARES RDA3 model) in accordance with ASTM D4440.

A person of ordinary skill in the art will recognize additional melt viscosity ranges within the explicitly disclosed ranges are contemplated and within the scope of the present disclosure.

The (t-PAES) polymer of the present invention advantageously possesses a glass transition temperature of at least 210° C., preferably 220° C., more preferably at least 230° C.

Glass transition temperature (Tg) is generally determined by DSC, according to ASTM D3418.

The (t-PAES) polymer of the present invention advantageously possesses a melting temperature of at least 340° C., preferably 370° C., more preferably at least 375° C. The (t-PAES) polymer of the present invention advantageously possesses a melting temperature less than or equal to 430° C., preferably less than or equal to 420° C. and more preferably less than or equal to 410° C.

The melting temperature (Tm) is generally determined by DSC, according to ASTM D3418.

It is known that the crystallinity of polymers is characterized by their degree of crystallinity and a semi-crystalline polymer having a higher number average molecular weight (Mₙ) is in general characterized by having a lower degree of crystallinity.

The Applicant has surprisingly found that the (t-PAES) polymers of the present invention having a number average molecular weight (Mₙ) ranging from 29,000 to 90,000 g/mol, preferably from 43,000 to 80,000 g/mol maintain good crystallization properties such as high percent crystallinity.

The degree of crystallinity can be determined by different methods known in the art such as notably by Wide Angle X-Ray diffraction (WAXD) and Differential Scanning Calorimetry (DSC).

For the purpose of the present invention, the degree of crystallinity has been measured by DSC on compression molded samples of the (t-PAES) polymers of the present invention, as described in detail in the Examples.

According to the present invention, molded parts of the (t-PAES) polymer have advantageously a degree of crystallinity less than or equal to 30%, preferably less than or equal to 28%, preferably less than or equal to 26%. preferably less than or equal to 18%, preferably less than or equal to 12%.

According to the present invention, molded parts of the (t-PAES) polymer have advantageously a degree of crystallinity greater than or equal to 5%, preferably greater than or equal to 7% and more preferably greater than or equal to 8%.

Good results were obtained when molded parts of the (t-PAES) polymer had a degree of crystallinity ranging from 9 to 25%.

A person of ordinary skill in the art will recognize that additional crystallinity ranges within the explicitly disclosed ranges are contemplated and within the scope of the present disclosure.

The Applicant has found that the (t-PAES) polymers of the present invention has a solubility in an aqueous sulfuric acid solution having a density of 1.84 g/cm³ advantageously of less than or equal to 10.0 g/l, preferably less than or equal to 1.00 g/1 and more preferably less than or equal to 0.50 g/l.

As said, the (t-PAES) polymer of the present invention has been found to possess an excellent ductility, in other words, the (t-PAES) polymer of the present invention have high tensile yield elongation and tensile elongation at break values.

The (t-PAES) polymer of the present invention advantageously possesses a tensile yield elongation, as measured according to ASTM D638, greater than or equal to 2%, preferably greater than or equal to 3%, more preferably greater than or equal to 4%.

The (t-PAES) polymer of the present invention advantageously possesses a tensile yield elongation, as measured according to ASTM D638, equal to or less than 25%, preferably equal to or less than 20%, more preferably equal to or less than 18%.

The (t-PAES) polymer of the present invention advantageously possesses a tensile elongation at break, as measured according to ASTM D638, greater than or equal to 9%, preferably greater than or equal to 10%, more preferably greater than or equal to 11%.

The (t-PAES) polymer of the present invention advantageously possesses a tensile elongation at break, as measured according to ASTM D638, equal to or less than 40%, preferably equal to or less than 35%, more preferably equal to or less than 30%.

“Melt stability” as used herein means the melt stability as measured on a compression molded disk (25 mm in diameter by 3 mm thickness) according to ASTM D4440 under the following conditions: under nitrogen, 420° C., 10 rad/s, 5% strain.

The complex viscosity at 40 minutes (η₄₀) and at 10 minutes (η₁₀) was is ratioed to estimate the melt stability. A ratio value η₄₀/η₁₀ closer to 1 indicates a more melt stable product. If the material releases volatiles during the testing due to low melt stability, swelling of the sample may be observed during testing. The results of the viscosity readings obtained with swelling of the sample are not considered accurate.

Preferably, the (t-PAES) polymer exhibits no swelling during the stability testing (as evidenced by the absence of change in gap between the fixtures during the 40-minute test) and has a melt stability (η₄₀/η₁₀) ranging from 0.90 to 1.40, preferably from 0.90 to 1.25, preferably from 0.90 to 1.10.

Preferably, the (t-PAES) polymer has a melt stability (η₄₀/η₁₀) ranging from 1.00 to 1.10.

According to exemplary embodiments, the (t-PAES) polymer has a melt stability (η₄₀/η₁₀) that does not exceed 1.40, preferably 1.25, preferably 1.10.

A person of ordinary skill in the art will recognize that additional melt stability ranges within the explicitly disclosed ranges are contemplated and within the scope of the present disclosure.

“High melt stability” as used herein means any melt stability described above for the (t-PAES) polymer of the present invention.

Method for Making the (t-PAES) Polymer

Surprisingly and unexpectedly, it has been found that polyarylene ether sulfone (PAES) polymers comprising moieties derived from incorporation of 4,4″-terphenyl-p-diol and having a high melt stability can be prepared.

Exemplary embodiments are directed to a method for making a (t-PAES) polymer including recurring units (Rₜ) of formula (Sₜ):

-E-Ar¹—SO₂—[Ar²-(T-Ar³)ₙ—SO₂]ₘ—Ar⁴— (formula Sₜ)
wherein:
   n and m, equal to or different from each other, are independently zero or an integer ranging from 1 to 5,
   each of Ar¹, Ar², Ar³ and Ar⁴ equal to or different from each other, is an aromatic moiety,
   T is a bond or a divalent group optionally comprising one or more than one heteroatom; preferably T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

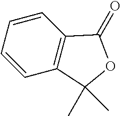

E is of formula (Eₜ):

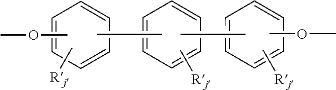

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
   j′ is zero or an integer ranging from 1 to 4.

Preferably, the (t-PAES) polymer has a ¹H NMR signal from about 8.1 ppm to about 8.3 ppm of ≤1.

Preferably the (t-PAES) polymer includes more than 50% moles of the recurring units (Rₜ).

Thus, exemplary embodiments are directed to a method for making a (t-PAES) polymer, including:
a) forming a premix including:
   at least one polar aprotic solvent;
   at least one alkali metal carbonate, and
   at least one dihydroxyaryl compound [diol (AA)] of Formula (T):

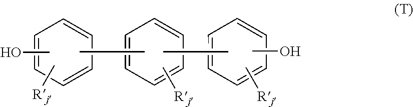

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
   j′ is zero or an integer ranging from 1 to 4; and
b) reacting the premix with at least one dihaloaryl compound [dihalo(BB)] of Formula (S):

X—Ar¹—SO₂—[Ar²-(T-Ar³)ₙ—SO₂]ₘ—Ar⁴—X′ (S)
wherein:
   n and m, equal to or different from each other, are independently zero or an integer ranging from 1 to 5;
   X and X′ are independently selected from F, Cl, Br, and I, preferably Cl or F, most preferably F.
   each of Ar¹, Ar², Ar³ and Ar⁴′ equal to or different from each other, is an aromatic moiety;
   T in Formula (S) is a bond or a divalent group optionally including one or more than one heteroatom; preferably T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

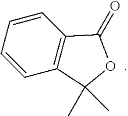

Preferably, the (t-PAES) polymer has a ¹H NMR signal from about 8.1 ppm to about 8.3 ppm of ≤1.

Preferably, the premix is substantially free of potassium hydroxide (KOH), more preferably, the premix does not include potassium hydroxide (KOH).

Optionally, the premix may additionally include at least one dihydroxyaryl compound [diol (A′A′)] different from diol (AA), as detailed above.

Optionally, step b) may include reacting the premix with at least one dihaloaryl compound [dihalo (B′B′)] different from dihalo (BB), as detailed above.

Step b) may include forming a monomer mixture, and in exemplary embodiments, the overall amount of halo-groups and hydroxyl-groups of the monomers of the monomer mixture is substantially equimolecular, so as to obtain a (t-PAES) polymer having a Mₙ of at least 25,000 g/mol, wherein the reaction is carried out at a total % monomer mixture concentration [total % monomers, herein after] equal to or more than 22% and less than or equal to 50% with respect to the combined weight of monomer mixture and solvent mixture.

For the purpose of the present invention, the term” total % monomers′ is defined as the sum of the weight of all monomers initially present at the start of the reaction in the monomer mixture in grams, designated as M_{wt}, divided by the combined weight of all monomers initially present in the monomer mixture and of the solvent mixture, wherein the weight of the solvent mixture in grams is designated as S_{wt}.

The total % monomers is thus equal to the formula:

100×M_{wt}/(M_{wt}+S_{wt}).

The total % monomers is preferably equal to or more than 24%, more preferably equal to or more than 25%.

The total % monomers is in general less than or equal to 60%, preferably less than or equal to 50%, more preferably less than or equal to 45% and even more preferably less than 42%.

Very good results have been obtained at a total % monomers in a range from 25% -42%.

For the purpose of the present invention, the expression “substantially equimolecular” used with reference to the overall amount of halo-groups and hydroxyl-groups of the monomers initially present at the start of the reaction of the monomer mixture, as above detailed, is to be understood that the molar ratio of the overall amount of hydroxyl groups of the monomers of the monomer mixture to the overall amount of halo groups of the monomers of the monomer mixture is greater than or equal to 0.988, more preferably greater than or equal to 0.990, even more preferably greater than or equal to 0.992, most preferably greater than or equal to 0.995. It is further understood that the molar ratio of the overall amount of hydroxyl groups of the monomers of the monomer mixture to the overall amount of halo groups of the monomers of the monomer mixture is less than or equal to 1.012, preferably less than or equal to 1.010, more preferably less than or equal to 1.008, most preferably less than or equal to 1.005. Good results were obtained when the molar ratio of the overall amount of hydroxyl groups of the monomers of the monomer mixture to the overall amount of halo groups of the monomers of the monomer mixture is about 1.00.

If desired, an additional amount of the dihalo(BB), as described above, and/or dihalo (B′B′), as described above, can be added to the reaction mixture when the reaction is essentially complete to end-cap the (t-PAES) polymer. Accordingly, in exemplary embodiments the method may include an additional step of end-capping the (t-PAES) polymer by adding an additional amount of the dihaloaryl compound [dihalo(BB)] in molecular excess.

For the purpose of the present invention, the expression “essentially complete” used with reference to the reaction is to be understood that the amount of all monomers which were initially present at the start of the reaction in the monomer mixture is less than or equal to 1.5% mol, preferably less than or equal to 1% mol, relative to the total amount of all monomers which were initially present at the start of the reaction.

Said additional amount, expressed in a molar amount with respect to the total amount of moles of the diol (AA), as detailed above and optionally the diol (A′A′), as detailed above, is typically in the range from about 0.1 to 15% mol, with respect to the total amount of moles of the diol (AA), as detailed above, and optionally of the diol (A′A′), preferably from 0.2 to 10% mol, more preferably from 0.5 to 6% mol.

If desired, the solvent mixture can further comprise any end-capping agent [agent (E)]. Said agent (E) is in general selected from a halo compound comprising only one reactive halo group [agent (MX)] and a hydroxyl compound comprising only one reactive hydroxy group [agent (MOH)].

The expression ‘halo compound comprising only one reactive halo group [agent (MX)]’ is intended to encompass not only monohalogenated compounds but also halogenated compounds comprising more than one halo group, but wherein only one of said halo group is reactive.

It is nevertheless generally preferred that said agent (MX) comprises only one halo group.

Thus, agent (MX) is preferably selected from 4-monochlorodiphenylsulfone, 4-mono fluorodiphenylsulfone, 4-monofluorobenzophenone, 4-monochlorobenzophenone, alkylchlorides such as methylchloride and the like.

Similarly, the expression ‘hydroxyl compound comprising only one reactive hydroxy group [agent (MOH)]’ is intended to encompass not only monohydroxylated compounds but also hydroxylated compounds comprising more than one hydroxy group, but wherein only one of said hydroxy group is reactive.

It is nevertheless generally preferred that said agent (MOH) comprises only one hydroxy group.

Thus, agent (MOH) is preferably selected from terphenol, phenol, 4-phenylphenol, 4-phenoxyphenol, 4-monohydroxydiphenylsulfone, 4-monohydroxybenzophenone.

In the process of the present invention, the total amount of agent (E), computed as

$$agent ( E ) ( \% moles ) = [ \frac{moles of agent ( MX )}{total moles of ( dihalo ( BB ) + dihalo ( {B}^{′} {B}^{′} ) )} + \frac{moles of agent ( MOH )}{total moles of ( diol ( AA ) + diol ( {A}^{′} {A}^{′} ) )} ] \cdot 100$$

is comprised between 0.05 and 20% moles, being understood that the agent (E) might advantageously be agent (MX) alone, agent (MOH) alone or a combination thereof. In other words, in above mentioned formula, the amount of agent (MX) with respect to the total moles of dihalo(BB), as detailed above, optionally of dihalo (B′B′), as detailed above, can be from 0.05 to 20% moles, the amount of agent (MOH) with respect to the total moles of diol (AA), as detailed above, and optionally of the diol (A′A′), can be from 0.05 to 20% moles, with the additional provisions that their sum is of 0.05 to 20% moles.

The amount of agent (E), as above described, is of at most 10% moles, preferably at most 8% moles, more preferably at most 6% moles.

The amount of agent (E), as above described, is of at least 1% moles, preferably at least 2% moles.

The agent (E) can be present at the start of the reaction in the monomer mixture or/and can be added to the reaction mixture when the reaction is essentially complete.

The agent (E) can be added with the aim to control the upper limit of the number average molecular weight (Mₙ) of the (t-PAES) polymer, as detailed above.

The aromatic moiety in each of Ar¹, Ar², Ar³ and Ar⁴ equal to or different from each other and at each occurrence is preferably complying with following formulae:

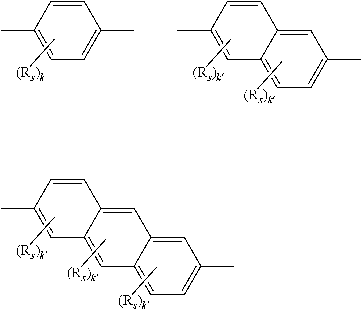

wherein:
   each Rₛ is independently selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
   k is zero or an integer ranging from 1 to 4; k′ is zero or an integer ranging from 1 to 3.

Preferred dihalo (BB) are those of formulae (S′-1) to (S′-4), as shown below:

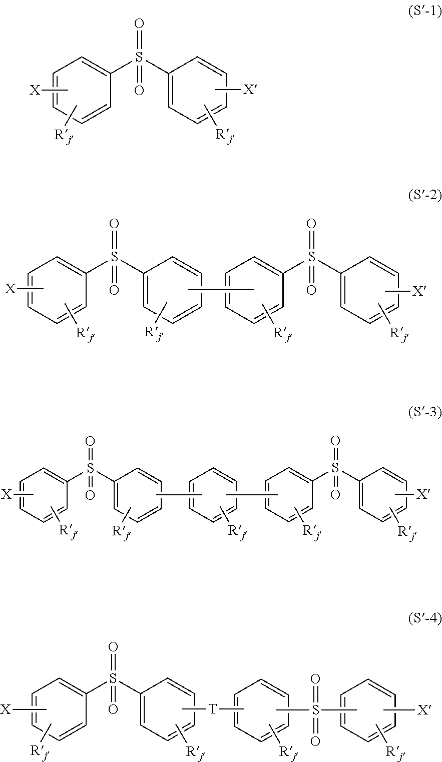

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
   j′ is zero or an integer ranging from 1 to 4,
   T is a bond or a divalent group optionally comprising one or more than one heteroatom; preferably T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

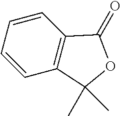

X and X′, equal to or different from each other, are independently a halogen atom, preferably Cl or F.

More preferred dihalo (BB) are those complying with following formulae shown below:

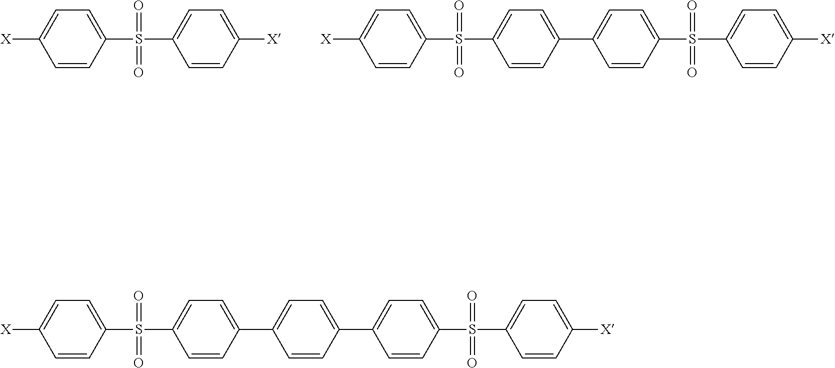

wherein X and X′ are as defined above, X and X′, equal to or different from each other, are preferably Cl or F. More preferably X and X′ are F.

Preferred dihaloaryl compounds [dihalo (BB)] are 4,4′-difluorodiphenyl sulfone (DFDPS), 4,4′-dichlorodiphenyl sulfone (DCDPS), 4,4′-chlorofluorodiphenyl sulfone or a mixture thereof. Most preferred dihalo (BB) is 4,4′-difluorodiphenyl sulfone (DFDPS) or a mixture of DCDPS and DFDPS.

Among dihaloaryl compound [dihalo (B′B′)] different from dihalo (BB) mention can be notably made of dihalo (B′B′) of formula (K):

X—Ar⁵—CO—[Ar⁶-(T-Ar⁷)ₙ—CO]ₘ—Ar⁸—X′ (formula K)
wherein:
   n and m, equal to or different from each other, are independently zero or an integer ranging from 1 to 5,
   each of Ar⁵, Ar⁶, Ar⁷ and Ar⁸ equal to or different from each other, is an aromatic moiety,
   T is a bond or a divalent group optionally comprising one or more than one heteroatom; preferably T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

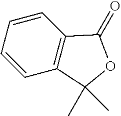

X and X′, equal to or different from each other, are independently a halogen atom, preferably Cl or F.

More preferred dihalo (B′B′) are those complying with following formulae shown below:

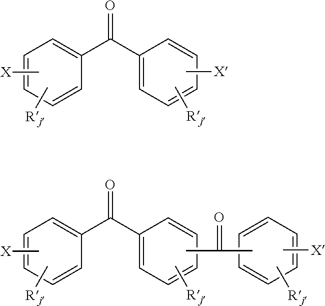

wherein:
   each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
   j′ is zero or an integer ranging from 1 to 4;
wherein X and X′ are as defined above, X and X′, equal to or different from each other, are preferably Cl or F. More preferably X and X′ are F.

Preferred dihalo (B′B′) are 4,4′-difluorobenzophenone, 4,4′-dichlorobenzophenone and 4-chloro-4′-fluorobenzophenone, with 4,4′-difluorobenzophenone being particularly preferred.

Among dihydroxyl compounds [diols (A′A′)] different from diol (AA), as above detailed, mention can be of compounds of formula (D):

HO—Ar⁹-(T′-Ar¹⁰)ₙ—O—H formula (D)
wherein:
   n is zero or an integer ranging from 1 to 5;
   each of Ar⁹ and Ar¹⁰, equal to or different from each other, is an aromatic moiety of the formula:

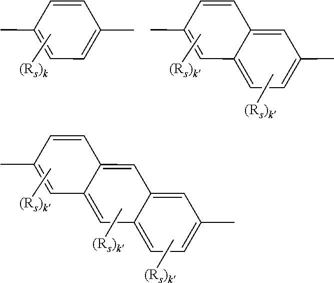

wherein:
   each Rₛ is independently selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
   k is zero or an integer ranging from 1 to 4; k′ is zero or an integer ranging from 1 to 3;
   T′ is a bond or a divalent group optionally comprising one or more than one heteroatom; preferably T is selected from a bond, —SO₂—, —CH₂—, —C(O)—, —C(CH₃)₂—, —C(CF₃)₂—, —C(═CCl₂)—, —C(CH₃)(CH₂CH₂COOH)—, and a group of formula:

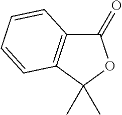

Among preferred dihydroxyl compounds [diols (A′A′)] different from diol (AA), as above detailed, suitable for being used in the process of the present invention, mention may be notably made of the following molecules:

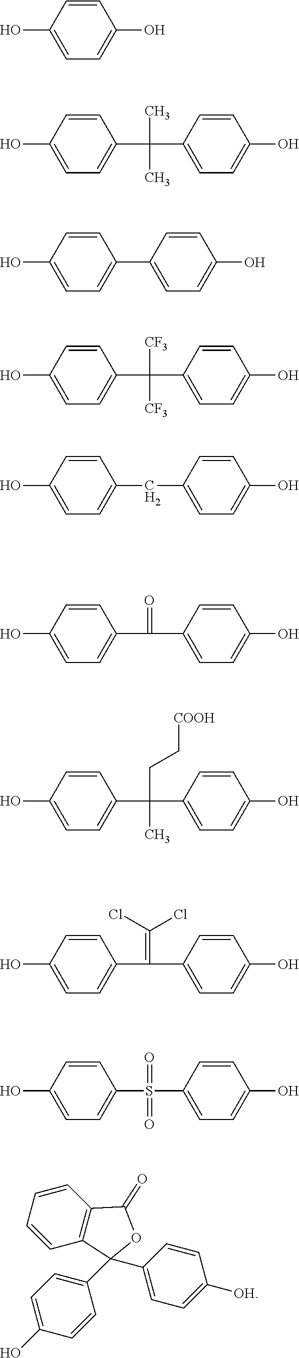

According to all embodiments of the present invention, the diol (AA) and dihalo (BB) and all other optional components (e.g. diol (A′A′) and dihalo (B′B′)) are dissolved or dispersed in a solvent mixture comprising a polar aprotic solvent.

As polar aprotic solvents, mention can be made of sulfur-containing solvents such as notably aromatic sulfones and aromatic sulfoxides and more specifically diaromatic sulfones and diaromatic sulfoxides according to the general formulae below:

R′—SO₂—R″ or R′—SO—R″
wherein R′ and R″, equal to or different from each other, are independently aryl, alkaryl and araryl groups.

More preferred polar aprotic solvents are those complying with following formulae shown below:

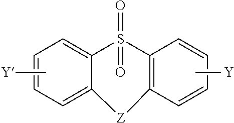

wherein Y and Y′, equal to or different from each other, are independently selected from halogen, alkyl, alkenyl, alkynyl, aryl, alkaryl, aralkyl; Z is a bond, oxygen or two hydrogens (one attached to each benzene ring).

Specifically, among the sulfur-containing solvents that may be suitable for the purposes of this invention are diphenyl sulfone, phenyl tolyl sulfone, ditolyl sulfone, xylyl tolyl sulfone, dixylyl sulfone, tolyl paracymyl sulfone, phenyl biphenyl sulfone, tolyl biphenyl sulfone, xylyl biphenyl sulfone, phenyl naphthyl sulfone, tolyl naphthyl sulfone, xylyl naphthyl sulfone, diphenyl sulfoxide, phenyl tolyl sulfoxide, ditolyl sulfoxide, xylyl tolyl sulfoxide, dixylyl sulfoxide, dibenzothiophene dioxide, and mixtures thereof.

Very good results have been obtained with diphenyl sulfone.

Other carbonyl containing polar aprotic solvents, including benzophenone may be used in exemplary embodiments.

If desired, an additional solvent can be used together with the polar aprotic solvent which forms an azeotrope with water, whereby water formed as a by-product during the polymerization may be removed by continuous azeotropic distillation throughout the polymerization.

The by-product water and carbon dioxide possibly formed during the polymerization can alternatively be removed using a controlled stream of an inter gas such as nitrogen or argon over and/or in to the reaction mixture in addition to or advantageously in the absence of an azeotrope-forming solvent as described above.

For the purpose of the present invention, the term “additional solvent” is understood to denote a solvent different from the polar aprotic solvent and the reactants and the products of said reaction.

The additional solvent that forms an azeotrope with water will generally be selected to be inert with respect to the monomer components and polar aprotic solvent. Suitable azeotrope-forming solvents for use in such polymerization processes include aromatic hydrocarbons such as benzene, toluene, xylene, ethylbenzene, chlorobenzene and the like.

The azeotrope-forming solvent and polar aprotic solvent are typically employed in a weight ratio of from about 1:10 to about 1:1, preferably from about 1:5 to about 1:3.

The alkali metal carbonate is preferably sodium carbonate, potassium carbonate, rubidium carbonate and cesium carbonate. Sodium carbonate and especially potassium carbonate are preferred. Mixtures of more than one carbonate can be used, for example, a mixture of sodium carbonate or bicarbonate and a second alkali metal carbonate or bicarbonate having a higher atomic number than that of sodium.

Preferably, at least 50% by weight of the at least one alkali metal carbonate is an alkali metal carbonate other than potassium carbonate. In some embodiments, at least 60%, preferably at least 70%, preferably at least 80%, preferably at least 90%, preferably at least 95%, preferably at least 99%, preferably more than 99%, preferably more than 99.5%, preferably 100% by weight of the at least one alkali metal carbonate is an alkali metal carbonate other than potassium carbonate.

Preferably, at least 50% by weight of the at least one alkali metal carbonate is sodium carbonate. More preferably, at least 50% of the at least one alkali metal carbonate is sodium carbonate and the remainder is potassium carbonate. In some embodiments, at least 60%, preferably at least 70%, preferably at least 80%, preferably at least 90%, preferably at least 95%, preferably at least 99%, preferably more than 99%, preferably more than 99.5%, preferably 100% by weight by weight of the at least one alkali metal carbonate is sodium carbonate.

A person of ordinary skill in the art will recognize additional ranges within the explicitly disclosed ranges are contemplated and within the scope of the present disclosure.

The amount of said alkali metal carbonate used, when expressed by the ratio of the equivalents of alkali metal (M) per equivalent of hydroxyl group (OH) [eq. (M)/eq. (OH)] ranges from 0.95 to 1.50, preferably from 1.00 to 1.30, more preferably from about 1.00 to 1.20, most preferably from about 1.00 to 1.10 being understood that above mentioned hydroxyl group equivalents are comprehensive of those of the diol (AA), and, if present, of diol (A′A′). Very good results have been obtained with a ratio of eq. (M)/eq. (OH) of 1.01-1.10.

It has surprisingly been found that the use of an optimum amount of alkali metal carbonate allows reducing significantly the reaction times of the process of the present invention while avoiding using excessive amounts of alkali metal carbonate which leads to higher costs and more difficult polymer purifications.

The use of an alkali metal carbonate having an average particle size of less than or equal to about 200 μm, preferably of less than or equal to about 150 μm preferably of less than or equal to about 75 μm, more preferably <45 μm is especially advantageous. The use of an alkali metal carbonate having such a particle size permits the synthesis of the polymers with desirable molecular weights.

If desired, at least one salt (S1) able to react with a fluoride salt (S2) can be added to the reaction mixture. Said fluoride salt (S2) can be formed as one of the by-products during the polymerization reaction when X or/and X′ in dihalo (BB) and/or dihalo (B′B′) is F. Examples of such fluoride salt (S2) are notably sodium fluoride and potassium fluoride. Suitable salts (S1) for use in such polymerization processes include lithium chloride, calcium chloride and magnesium chloride. Lithium chloride is most preferred.

The process according to exemplary embodiments is advantageously pursued while taking care to avoid the presence of any reactive gases in the reactor. These reactive gases may be notably oxygen, water and carbon dioxide. O₂ is the most reactive and should therefore be avoided.

In a particular embodiment, the reactor should be evacuated under pressure or under vacuum and filled with an inert gas including less than 20 ppm of reactive gases, and in particular less than 10 ppm of O₂. Preferably, the reactor is under an inert atmosphere during forming of the premix. Preferably, the reaction in step b) of the method described above is performed under an inert atmosphere. Preferably, the reactor is under an inert atmosphere prior to any heating step. The inert gas is any gas that is not reactive under normal circumstances. It may be chosen from nitrogen, argon or helium. The inert gas contains preferably less than or equal to 10 ppm oxygen, 20 ppm water and 20 ppm carbon dioxide.

Generally, after an initial heat up period, the temperature of the reaction mixture will be maintained in a range of advantageously from 250 to 350° C., preferably from 300 to 340° C. Good results were obtained at a temperature of about 320° C.

In one embodiment the alkali metal carbonate, in particular potassium carbonate, is added to the monomer mixture at a temperature ranging from 25 to 280° C., preferably from 120 to 270° C., more preferably from 180 to 250° C.

In a more preferred embodiment of the process of the invention, the alkali metal carbonate, in particular potassium carbonate is first added to the diol (AA), as described above, and optionally the diol (A′A′), as described above, in the solvent mixture, as described above, and the dihalo (BB), as detailed above and optionally the dihalo (B′B′), as detailed above, is then added to said reaction mixture at a temperature from 25 to 280° C., preferably from 120 to 270° C., more preferably from 180 to 250° C.

In general, the end-capping agent, as described above, is added to the reaction mixture, as described above, at a temperature from 250 to 350° C., preferably from 300 to 340° C.

The (t-PAES) polymer of the present invention, can notably be used in HP/HT applications.

Preferably, dihalo (BB), as detailed above and optionally the dihalo (B′B′) is added over a period of time ranging from 10 to 90 minutes, preferably 20 to 60 minutes.

The (t-PAES) polymer, can be processed to yield a shaped article by melt processing (including injection moulding, extrusion moulding, compression moulding), but also by other processing procedures such as notably spray coating, powder coating selective sintering, fused deposition modelling and the like.

It is another object of the present invention to provide a shaped article comprising the (t-PAES) polymer as described above. It is another object of the present invention to provide a shaped article comprising the (t-PAES) polymer prepared by the method described above.

The total weight of the (t-PAES) polymer, based on the total weight of the article, is advantageously more than 50%, preferably more than 80%, more preferably more than 90%, more preferably more than 95%, and more preferably more than 99%. The article may consist of, or consist essentially of, the (t-PAES) polymer or a composition comprising the (t-PAES) polymer.

Advantageously, the article may be an injection moulded article, an extrusion moulded article, a shaped article, a coated article, or a casted article.

Non limiting examples of articles include bearing articles such as radial and axial bearings for auto transmission, bearings used in dampers, shock absorbers, bearings in any kind of pumps, e.g., acid pumps; hydraulically actuated seal rings for clutch components; gears or the like.

In exemplary embodiments, the article is a bearing article. The bearing article may include several parts, wherein at least one of said parts, and optionally all of them, include the (t-PAES) polymer.

The (t-PAES) polymer can also notably be used for the manufacture of membranes, films and sheets, and three-dimensional moulded parts.

The (t-PAES) polymer can be advantageously processed to yield all of the above-mentioned articles by melt processing (including injection moulding, extrusion moulding, and compression moulding).

Non-limiting examples of shaped articles that can be manufactured from the (t-PAES) polymer using different processing technologies are generally selected from the group consisting of melt processed films, solution processed films (porous and non porous films, including solution casted membranes, and membranes from solution spinning), melt process monofilaments and fibers, solution processed monofilaments, hollow fibers and solid fibers, and injection and compression molded objects.

Further, shaped articles manufactured from the (t-PAES) polymer of the invention can be three-dimensional molded parts.

Exemplary embodiments also include compositions that comprise at least one of the (t-PAES) polymers described herein, preferably with at least one other ingredient. Said other ingredient can be another polymer or copolymer. It can also be a polymer other than the polymers described herein, such as polyaryletherketone or polyaryelthersulfone. Other ingredients may also include a non-polymeric ingredient such as a solvent, a filler, a lubricant, a mould release agent, an antistatic agent, a flame retardant, an anti-fogging agent, a matting agent, a pigment, a dye, an optical brightener, a stabilizer (UV, thermal, and/or oxygen stabilizer) or a combination thereof.

The polymer composition according to exemplary embodiments may be a filled or unfilled composition. The composition may include reinforcing fillers selected from continuous or discontinuous fibrous fillers and particulate fillers. Reinforcing fillers may include, for example, one or more mineral fillers, such as notably talc, mica, kaolin, calcium carbonate, calcium silicate, or magnesium carbonate; glass fiber; carbon fibers such as notably graphitic carbon fibers, amorphous carbon fibers, pitch-based carbon fibers, PAN-based carbon fibers; synthetic polymeric fiber; aramid fiber; aluminum fiber; aluminum silicate fibers; oxide of metals of such aluminum fibers; titanium fiber; magnesium fiber; boron carbide fibers; rock wool fiber; steel fiber; asbestos; wollastonite; silicon carbide fibers; boron fibers, boron nitride, graphene, carbon nanotubes (CNT), or a combination thereof.

Should the disclosure of any patents, patent applications, and publications which are incorporated herein by reference conflict with the description of the present application to the extent that it may render a term unclear, the present description shall take precedence.

It will be understood that all of the properties or attributes described herein for the (t-PAES) polymers are equally disclosed for (t-PAES) polymers made by the methods described herein. In addition, it will be understood that exemplary (t-PAES) polymers disclosed herein, or made by a method disclosed herein, may exhibit a combination of two or more of the properties or attributes described herein. As just one example, the (t-PAES) polymer may exhibit a melting temperature greater than or equal to 370° C. and a melt stability (η₄₀/η₁₀) less than 1.40 as described above.

The invention will be now described in more detail with reference to the following examples, whose purpose is merely illustrative and not intended to limit the scope of the invention.

### EXAMPLES

The invention will be now described in more details with reference to the following examples, whose purpose is merely illustrative and not intended to limit the scope of the invention.

### Raw Materials

1,1′:4′,1″-terphenyl-4,4″-diol was procured from Yongyi Chemicals Group Co. Ltd, China and purified by washing with ethanol/water (90/10) at reflux. The purity of the resulting material was shown to be higher than 94.0% area as measured by gas chromatography (GC).

GC analysis of 1,1′:4′,1″-terphenyl-4,4″-diol was performed on a 0.1/mL solution in N,N-dimethylformamide using an HP5890 series 11 gas chromatograph with a Restek RTx-5MS, 15m×0.25mm id×0.25 um film thickness column. The following GC conditions were used:
Helium flow rate: 1 mL/minute,
Injector temperature: 300° C.
FID temperature: 320° C.
Oven Temperature Program: 150° C., hold 1 minute, 30° C./minute to 325° C., hold 1 minute
Injection volume: 1 μL
Split 40:1

4,4′-difluorodiphenylsulfone was procured from Aldrich, St. Louis, Mo. (99% grade, 99.32% measured) or from Marshallton Research Laboratories, Inc., King, N.C. (99.92% pure by GC).

GC analysis of 4,4′-difluorodiphenylsulfone was performed on a 0.1 g/mL solution in acetone using an HP5890 series 11 gas chromatograph with a Restek RTx-5MS, 15m×0.25mm id>0.25 um film thickness column. The following GC conditions were used:
Helium flow rate: 1 mL/minute,
Injector temperature: 250° C.
FID temperature: 250° C.
Oven Temperature Program: 100° C., hold 1 minute, 30° C./minute to 250° C., hold 1 minute
Injection volume: 14
Split 40:1

Diphenyl sulfone (polymer grade) was procured from Proviron, Belgium (99.8% pure).

Sodium carbonate, light soda ash, with d99.5<500 μm, and d90<250 μm was procured from Solvay Chemicals, France.

Potassium carbonate with a d₉₀<45 μm was procured from Armand Products Company, Princeton, N.J.

Lithium chloride (99+%, ACS grade) was procured from Acros Organics, Belgium.

### Comparative Example 1

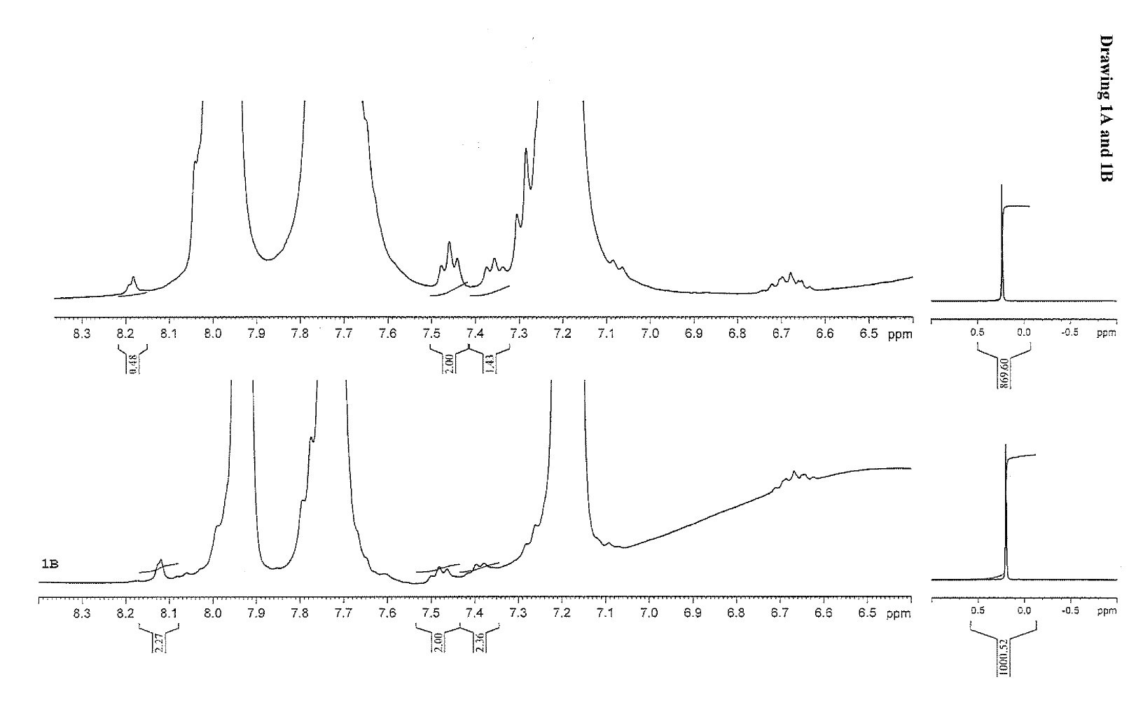

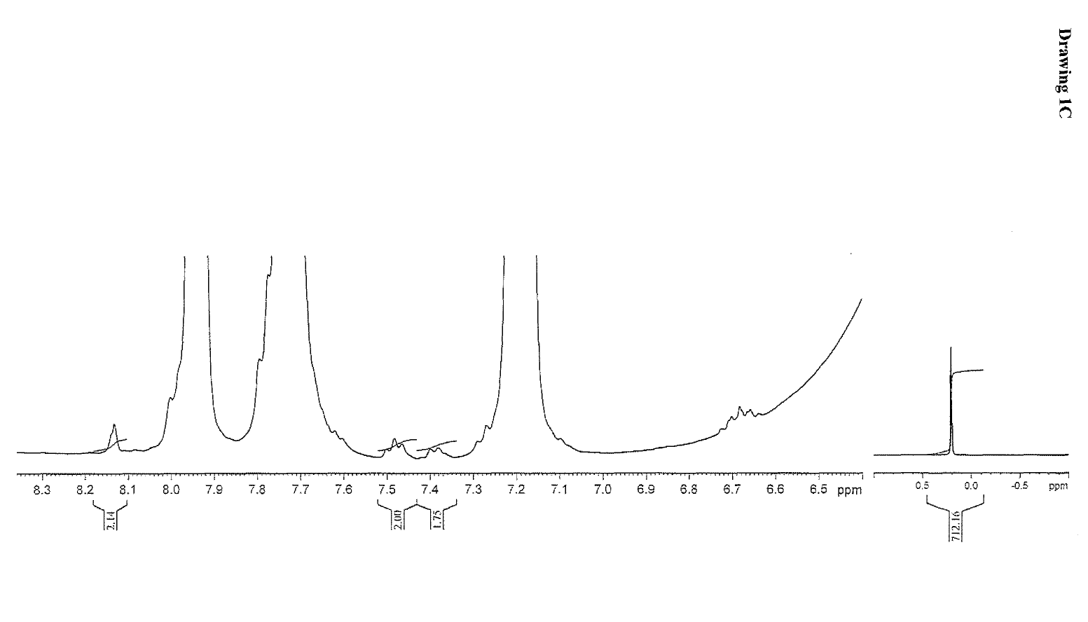

Comparative Example 1 was performed following the synthesis procedure described in example 12 of International Published Application No. WO95/31502, which is incorporated herein by reference in its entirety, but by using 100.00 g of diphenyl sulfone, 20.997 g of 1,1′:4′,1″-terphenyl-4,4″-diol, 20.524 g of 4,4′-difluorodiphenylsulfone and 11.284 g of potassium carbonate. The analysis of Comparative Example 1 is summarized in Table 2 below, and the NMR spectrum is presented in FIG. 1A.

### Comparative Example 2

In a 500 mL 4-neck reaction flask fitted with a stirrer, a N₂ inlet tube, a Claisen adapter with a thermocouple plunging in the reaction medium, and a Dean-Stark trap with a condenser and a dry ice trap were introduced 204.50 g of diphenyl sulfone, 66.430 g of 1,1′:4′,1″-terphenyl-4,4″-diol and 64.071 g of 4,4′-difluorodiphenylsulfone. The flask content was evacuated under vacuum and then filled with high purity nitrogen (including less than or equal to 10 ppm O₂). The reaction mixture was then placed under a constant nitrogen purge (60 mL/min).

The reaction mixture was heated slowly to 220° C. At 220° C., 35.349 g of K₂CO₃ was added via a powder dispenser to the reaction mixture over 30 minutes. At the end of the addition, the reaction mixture was heated to 320° C. at 1° C./minute. After 61 minutes at 320° C., 1.281 g of 4,4′-difluorodiphenylsulfone was added to the reaction mixture while keeping a nitrogen purge on the reactor. After 2 minutes, 10.682 g of lithium chloride was added to the reaction mixture. 2 minutes later, another 0.641 g of 4,4′-difluorodiphenylsulfone was added to the reactor and the reaction mixture was kept at temperature for 5 minutes.

The reactor content was then poured from the reactor into a stainless steel pan and cooled. The solid was broken up and ground in an attrition mill through a 2 mm screen. Diphenyl sulfone and salts were extracted from the mixture with acetone, then water at a pH between 1 and 12, and then with acetone. The powder was then removed from the reactor and dried at 120° C. under vacuum for 12 hours yielding 115 g of a light brown powder. The analysis of

Comparative Example 2 is summarized in Table 2 below, and the NMR spectrum is presented in FIG. 1B.

### Comparative Example 3

Comparative Example 2 was repeated but with a 65-minute reaction at 320° C. The analysis of Comparative Example 3 is summarized in Table 2 below, and the NMR spectrum is presented in FIG. 1C.

### Example 4

In a 500 mL 4-neck reaction flask fitted with a stirrer, a N₂ inlet tube, a Claisen adapter with a thermocouple plunging in the reaction medium, and a Dean-Stark trap with a condenser and a dry ice trap were introduced 97.38 g of diphenyl sulfone, 28.853 g of 1,1′:4′,1″-terphenyl-4,4″-diol, 12.184 g of Na₂CO₃, and 0.076 g of K₂CO₃. The flask content was evacuated under vacuum and then filled with high purity nitrogen (including less than or equal to 10 ppm O₂). The reaction mixture was then placed under a constant nitrogen purge (60 mL/min).

The reaction mixture was heated slowly to 220° C. At 220° C., 28.0514 g of 4,4′-difluorodiphenylsulfone was added via a powder dispenser to the reaction mixture over 20 minutes. At the end of the addition, the reaction mixture was heated to 320° C. at 1° C./minute. After 90 minutes at 320° C., 2.237 g of 4,4′-difluorodiphenylsulfone was added to the reaction mixture while keeping a nitrogen purge on the reactor. After 15 minutes, 1.166 g of lithium chloride was added to the reaction mixture. 10 minutes later, another 0.280 g of 4,4′-difluorodiphenylsulfone was added to the reactor and the reaction mixture was kept at temperature for 10 minutes.

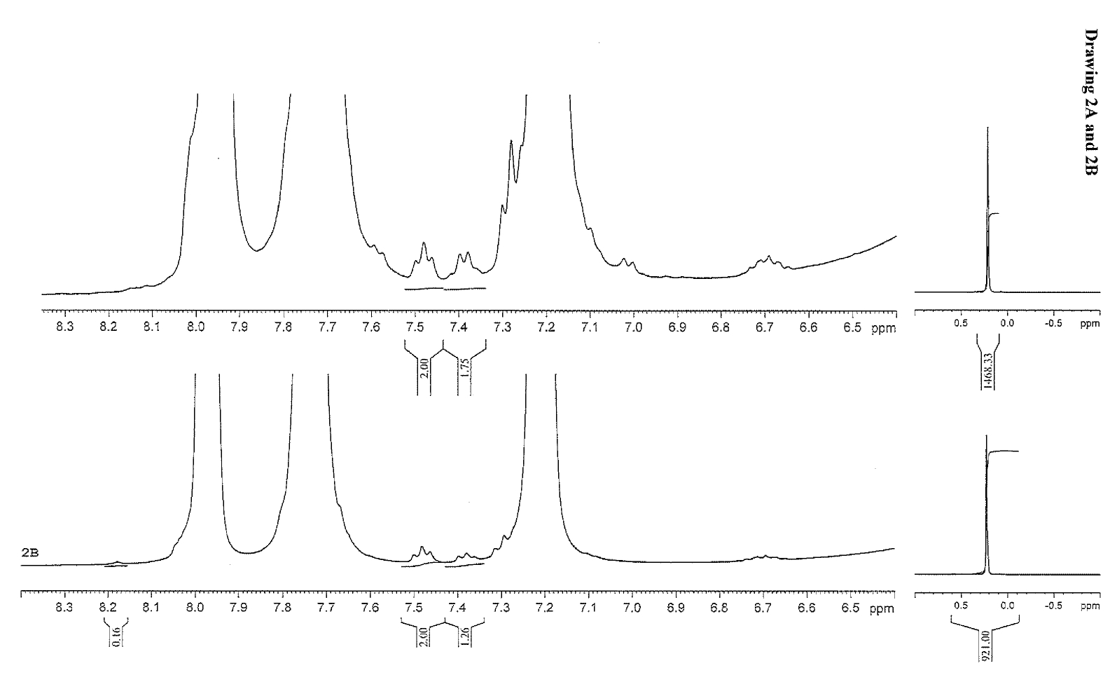

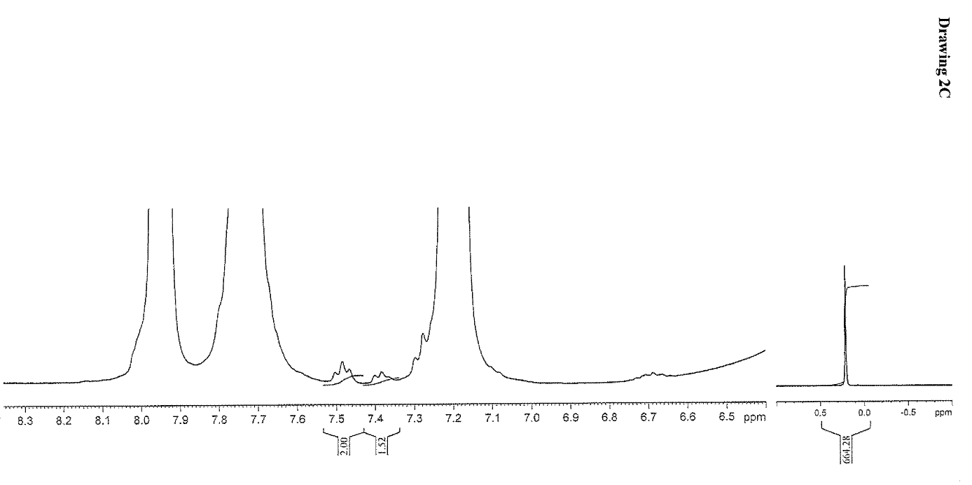

The reactor content was then poured from the reactor into a stainless steel pan and cooled. The solid was broken up and ground in an attrition mill through a 2 mm screen. Diphenyl sulfone and salts were extracted from the mixture with acetone, then water at pH between 1 and 12, then with acetone. The powder was then removed from the reactor and dried at 120° C. under vacuum for 12 hours yielding 48 g of a light brown powder. The analysis of Example 4 is summarized in Table 2 below, and the NMR spectrum is presented in FIG. 2A.

### Example 5

Example 4 was repeated but with 122-minute reaction time at 320° C. The analysis of Example 5 is summarized in Table 2 below, and the NMR spectrum is presented in FIG. 2B.

### Example 6

In a 500 mL 4-neck reaction flask fitted with a stirrer, a N₂ inlet tube, a Claisen adapter with a thermocouple plunging in the reaction medium, and a Dean-Stark trap with a condenser and a dry ice trap were introduced 89.26 g of diphenyl sulfone, 28.853 g of 1,1′:4′,1″-terphenyl-4,4″-diol, 12.184 g of Na₂CO₃ and 0.076 g of K₂CO₃. The flask content was evacuated under vacuum and then filled with high purity nitrogen (including less than or equal to 10 ppm O₂). The reaction mixture was then placed under a constant nitrogen purge (60 mL/min).

The reaction mixture was heated slowly to 220° C. At 220° C., 28.0514 g of 4,4′-difluorodiphenylsulfone was added via a powder dispenser to the reaction mixture over 20 minutes. At the end of the addition, the reaction mixture was heated to 320° C. at 1° C./minute. After 30 minutes at 320° C., 0.559 g of 4,4′-difluorodiphenylsulfone was added to the reaction mixture while keeping a nitrogen purge on the reactor. After 10 minutes, 1.166 g of lithium chloride was added to the reaction mixture. 10 minutes later, another 0.280 g of 4,4′-difluorodiphenylsulfone was added to the reactor and the reaction mixture was kept at temperature for 10 minutes.

The reactor content was then poured from the reactor into a stainless steel pan and cooled. The solid was broken up and ground in an attrition mill through a 2 mm screen. Diphenyl sulfone and salts were extracted from the mixture with acetone then water at pH between 1 and 12 then with acetone. The powder was then removed from the reactor and dried at 120° C. under vacuum for 12 hours yielding 43 g of a light brown powder. The analysis of Example 6 is summarized in Table 2 below, and the NMR spectrum is presented in FIG. 2C.

### Analytical Methods

The following characterizations were carried out on the (t-PAES) polymers of the Examples and Comparative Examples:

### Molecular Weight Measurements by a GPC Method

GPC conditions:
Pump: 515 HPLC pump manufactured by Waters
Detector: UV 1050 series manufactured by HP
Software: Empower Pro manufactured by Waters
Injector: Waters 717 Plus Auto sampler
Flow rate: 0.5 ml/min
UV detection: 270 nm
Column temperature: 40° C.
Column: 2× PL Gel mixed D, 5 micron, 300 mm×7.5 mm 5 micron manufactured by Agilent
Injection: 20μ liter
Runtime: 60 minutes
Eluent: N-Methyl-2-pyrrolidone (Sigma-Aldrich, Chromasolv Plus for HPLC>99%) with 0.1 mol Lithium bromide (Fisher make). Mobile phase should be store under nitrogen or inert environment
Calibration standard: Polystyrene standards part number PL2010-0300 manufactured by Agilent was used for calibration. Each vial contains a mixture of four narrow polydispersity polystyrene standards (a total 11 standard, 371100, 238700, 91800, 46500, 24600, 10110, 4910, 2590, 1570,780 used to establish calibration curve)
Concentration of standard: 1 milliliter of mobile phase added in to each vial before GPC injection for calibration
Calibration Curve: 1) Type: Relative, Narrow Standard Calibration 2) Fit: 3^{rd} order regression
Integration and calculation:

Empower Pro GPC software manufactured by Waters used to acquire data, calibration and molecular weight calculation. Peak integration start and end points are manually determined from significant difference on global baseline.

### Sample Preparation:

25 mg of the (t-PAES) polymer was dissolved in 10 ml of 4-chlorophenol upon heating at 170 to 200° C. A small amount (0.2 to 0.4 ml) of said solution obtained was diluted with 4 ml of N-Methyl-2-pyrrolidone. The resulting solution was passed through to GPC column according to the GPC conditions described above.

### NMR Determination of % Relative Signal at 8.1-8.3 ppm

The NMR spectra were acquired on a Bruker Avance 400 MHz spectrometer using a TBI (1H, 13C and 19F) gradient z probe at 30° C. The NMR spectra were referenced to the protonated residual peak of the solvent C₂HDCl₄ calibrated at 6.00 ppm for 1H dimension.

The polymers were dissolved at around 7% weight in pentafluorophenol solvent at 150-160° C. For the ¹H NMR acquisition and quantification, the NMR samples were prepared by dissolving an exact amount of each pentafluorophenol solution (around 400 mg) in 0.5 mL of C₂D₂Cl₄. Drops of OMCTS (octamethylcyclotetrasiloxane) were added as ¹H internal standard. For quantification we acquired ¹H{¹³C} NMR spectra (¹H NMR spectrum without 13C coupling to eliminate 13C satellites). This procedure was used for accurate integration of the signals that may overlap with some ¹³C NMR satellites. The quantification of each end chain was estimated (weight % in the polymer) using the quantity of the polymer present in the pentafluorophenol solution.

For the end chain observed in some spectra at 8.1-8.2 ppm, a relative proportion was estimated according to the following equation:

% relative signal 8.2ppm=[Integral (signal at 8.2 ppm)×24(=ΣH¹ OMCTS)×weight (OMCTS)]/[Integral (OMCTS at 0.2 ppm)×weight (sample)×concentration (polymer % weight in pentafluorophenol)×MW(OMCTS)]*1000

The ¹H NMR spectra of Comparative Examples C1, C2, and C3, are shown in FIG. 1 with labels A, B, and C, respectively. The ¹H NMR spectra of Examples 4, 5, and 6, are shown in FIG. 2 with labels A, B, and C, respectively.

### Determination of % Crystallinity and Melting Temperature of Molded Plaque

102 mm×102 mm×1.6 mm plaques were prepared from the (t-PAES) polymers by compression molding under the conditions shown in Table 1:

TABLE 1

| Step # | |
|---|---|
| 1 | preheat at 420° C. |
| 2 | 420° C./15 minutes, 2000 kg-f |
| 3 | 420° C./2 minutes, 2700 kg-f |
| 4 | cool down to 320° C. over 20 minutes, 2000 kg-f |
| 5 | 50 minute-hold at 320° C., 2000 kg-f |
| 6 | 25 minute-cool down to 30° C., 2000 kg-f |

The melting temperature and the crystallinity level of the material were determined on an annealed plaque by DSC, according to ASTM D3418-03, E1356-03, E793-06, E794-06 on TA Instruments Q20 with nitrogen as a carrier gas (99.998% purity, 50 mL/min). Temperature and heat flow calibrations were made using indium. The sample size was 5 to 7 mg. The weight was recorded ±0.01 mg.

The heat cycle was:
1^{st} heat cycle: 50.00° C. to 450.00° C. at 20.00° C./min, isothermal at 450.00° C. for 1 min.

The melting temperature (Tm melting point) was measured as the temperature at which the main melting endotherm is observed in the 1^{st} heat cycle. The enthalpy of fusion was determined on the 1^{st} heat scan. The heat of fusion was taken as the area over a linear baseline drawn from 260° C. to a temperature above the last endotherm (typically 430-440° C.). The level of crystallinity was calculated from the heat of fusion assuming 130 J/g for 100% crystalline material.

### Determination of Melt Stability

The melt stability was measured on a compression molded disk (25 mm in diameter by 3 mm thickness) with a TA ARES RDA3 rheometer according to ASTM D4440 under the following conditions: under nitrogen, 420° C., 10 rad/s, 5% strain.

The complex viscosity at 40 minutes and at 10 minutes was ratioed to estimate the melt stability. A ratio value η₄₀/η₁₀ closer to 1 indicates a more melt stable product.

TABLE 2

| | | | | | | Rel | | | | | | | | |
|---|---|---|---|---|---|---|---|---|---|---|---|---|---|---|
| | | | | | | integration | End groups | | | | | | | |
| | | | | | | of peak at | [Ar—H + | EG | | | η₁₀ | η₄₀ | | |
| Ex- ample | Mₙ | M_{w} | M_{z} | M_{w}/Mₙ | M_{z}M_{w} | δ = 8.2 ppm | Ar—F] (mol/wt %) | * Mn | Tm (° C.) | % cryst | min (Pa*s) | min (Pa*s) | $\frac{{η}_{40}}{{η}_{10}}$ | Observation dyn rheology test |
| C1 | 39902 | 102712 | 204347 | 2.57 | 1.99 | 1.3 | 0.985 | 393 | 378 | 30.6 | | | >>1 | Viscosity too |
| | | | | | | | | | | | | | | high, overloaded |
| | | | | | | | | | | | | | | system |
| C2 | 36221 | 105886 | 451433 | 2.92 | 4.26 | 7.9 | 0.710 | 257 | 368 | 18.2 | 11970 | 13760 | 1.15 | Swelling of the |
| | | | | | | | | | | | | | | sample observed |
| C3 | 41069 | 116512 | 427857 | 2.84 | 3.67 | 11.0 | 0.863 | 355 | 367 | 11.9 | | | >>1 | Heavy swelling of |
| | | | | | | | | | | | | | | the sample |
| | | | | | | | | | | | | | | observed, could |
| | | | | | | | | | | | | | | not be evaluated |
| | | | | | | | | | | | | | | for the test |
| | | | | | | | | | | | | | | duration |
| 4 | 29979 | 76121 | 147518 | 2.54 | 1.94 | <0.1 | 1.135 | 340 | 382 | 28.1 | N/A^{a} | N/A | N/A | Not measured |
| 5 | 46632 | 109792 | 180790 | 2.35 | 1.65 | 0.6 | 0.710 | 331 | 376 | 17.9 | 11710 | 12670 | 1.08 | No swelling |
| 6 | 50414 | 126958 | 223241 | 2.52 | 1.76 | <0.1 | 0.988 | 498 | 375 | 11.7 | 14700 | 16230 | 1.10 | No swelling |

^{a}The material was too brittle (low molecular weight) for a disk to be molded for the melt stability testing.

The crystallinity level of semi-crystalline (t-PAES) polymers normally decreases with decreasing molecular weight. The experimental results in Table 2 surprisingly show, however, that (t-PAES) polymers having low intensity ¹H NMR signals at about 8.2 ppm (for example less than or equal to 1) exhibit higher crystallinity than (t-PAES) polymers with a higher intensity signal at about 8.2 ppm. For example, the (t-PAES) polymer of Example 5 was unexpectedly found to exhibit a similar crystallinity level to the (t-PAES) polymer of Comparative Example C2, even though the (t-PAES) polymer of Example 5 has a higher molecular weight. Likewise, the (t-PAES) polymer of Example 6 was unexpectedly found to exhibit a similar crystallinity level to the (t-PAES) polymer of Comparative Example C3, even though the (t-PAES) polymer of Example 6 has a higher molecular weight. In the (t-PAES) polymers with low or zero intensity signals at 8.2 ppm (Examples 4, 5, and 6), the higher crystallinity is also exhibited in the higher melting points as compared with the melting points of Comparative Examples 2 and 3.

The melt stability was also be measured directly by dynamic rheology. The (t-PAES) polymers according to the invention (Examples 5 and 6) gave a ratio η₄₀/η₁₀ close to 1 with no swelling observed, demonstrating high melt stability.

On the contrary, the (t-PAES) polymers of Comparative Examples 1, 2, and 3 either exhibited a very strong increase in viscosity such that it overloaded the measuring cell or were prone to high degradation with release of volatiles, generating a strong swelling of the sample during testing.

### Further Inventive Concepts

In step b) described above, a total amount by weight of the at least one dihaloaryl compound [dihalo(BB)] and the at least one dihydroxyaryl compound [diol (AA)] may be equal to or greater than 22% and less than or equal to 50% of the combined weight of the at least one dihaloaryl compound [dihalo(BB)], the at least one dihydroxyaryl compound [diol (AA)], and the at least one solvent.

In some embodiments:
reacting the premix with the at least one dihaloaryl compound [dihalo(BB)] comprises forming monomer mixture; and
an overall amount of halo-groups and hydroxyl-groups in the monomer mixture is substantially equimolecular.

The at least one alkali metal carbonate may include at least 50% by weight of sodium carbonate.

The (t-PAES) polymer may have a number average molecular weight (Mₙ) of at least 25,000 g/mol, preferably ranging from 25,000 to 90,000 g/mol.

The (t-PAES) polymer may not exhibit an ¹H NMR signal at from about 8.1 ppm to about 8.3 ppm.

The (t-PAES) polymer may have a melt stability η₄₀ /η₁₀ ranging from about 0.9 to about 1.40.

The (t-PAES) polymer may have a high melt stability and a melting temperature (Tm) greater than or equal to 370° C.

The (t-PAES) polymer may have a polydispersity index of less than or equal to 4.0.

Exemplary embodiments include a method for making a shaped article comprising injection moulding, extrusion moulding or compression moulding the (t-PAES) polymer described herein.

Exemplary embodiments include a method for making a shaped article comprising injection moulding, extrusion moulding or compression moulding a (t-PAES) polymer prepared by the methods described herein.

Exemplary embodiments include a composition comprising any (t-PAES) polymer described herein.

Exemplary embodiments include a composition comprising any (t-PAES) polymer prepared by any method described herein.

1-15. (canceled)

16. A method for making a poly(aryl ether sulfone) polymer, (t-PAES) polymer, the method comprising:
a) forming a premix, the premix comprising:
at least one polar aprotic solvent;
at least one alkali metal carbonate; and
at least one dihydroxyaryl compound, diol (AA), of formula (T): 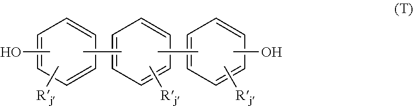
wherein:
each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
j′ is zero or an integer ranging from 1 to 4; and
b) reacting the premix with at least one dihaloaryl compound, dihalo(BB), of formula (S):
X—Ar¹—SO₂—[Ar²-(T-Ar³)ₙ—SO₂]ₘ—Ar⁴—X′ (S)
wherein:
n and m, equal to or different from each other, are independently zero or an integer ranging from 1 to 5;
X and X′ are independently selected from F, Cl, Br, and I;
each of Ar¹, Ar², Ar³ and Ar⁴, equal to or different from each other, is an aromatic moiety; and
T in formula (S) is selected from a bond, —CH₂—, —C(O)—, —C(CH₃)₂—, —C(CF₃)₂—, —C(═CCl₂)—, —C(CH₃)(CH₂CH₂COOH)—, and a group of formula:

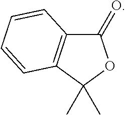

17. The method of claim 16, wherein the premix further comprises at least one dihydroxyaryl compound, diol (A′A′), different from the diol (AA).

18. The method of claim 16, further comprising reacting the premix with at least one dihaloaryl compound, dihalo (B′B′), different from dihalo (BB).

19. The method of claim 17, wherein the diol (A′A′) is selected from compounds of Formula (D):
HO—Ar⁹-(T′-Ar-¹⁰)ₙ—O—H (D)
wherein:
n is zero or an integer ranging from 1 to 5;
each of Ar⁹ and Ar¹⁰, equal to or different from each other, is an aromatic moiety of formula: 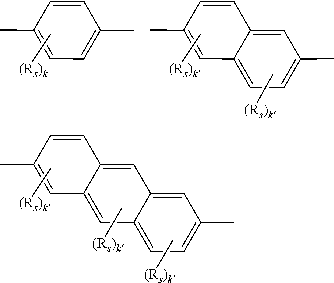
wherein:
each Rₛ is independently selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
k is zero or an integer ranging from 1 to 4; and
k′ is zero or an integer ranging from 1 to 3; and
T′ is selected from a bond, —SO₂—, —CH₂—, —C(O)—, —C(CH₃)₂—, —C(CF₃)₂—, —C(═CCl₂)—, —C(CH₃)(CH₂CH₂COOH)—, and a group of formula:

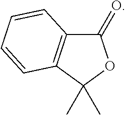

20. The method of claim 18, wherein the dihalo (B′B′) is a compound of formula (K):
X—Ar⁵—CO—[Ar⁶-(T-Ar⁷)ₙ—CO]ₘ—Ar⁸—X′ (K)
wherein:
n and m, equal to or different from each other, are independently zero or an integer ranging from 1 to 5;
each of Ar⁵, Ar⁶, Ar⁷ and Ar⁸, equal to or different from each other, is an aromatic moiety;
T is selected from a bond, —CH₂—, —C(O)—, —C(CH₃)₂—, —C(CF₃)₂—, —C(═CCl₂)—, —C(CH₃)(CH₂CH₂COOH)—, and a group of formula: 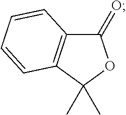
and
X and X′ are independently selected from F, Cl, Br, or I.

21. The method of claim 16, further comprising:
c) end-caping the (t-PAES) polymer by adding an additional amount of the dihaloaryl compound, dihalo(BB), in molecular excess.

22. The method of claim 16, wherein the premix is substantially free of potassium hydroxide (KOH).

23. The method of claim 16, wherein the (t-PAES) polymer has a ¹H NMR signal from about 8.1 ppm to about 8.3 ppm of ≤1.

24. A (t-PAES) polymer made by the method of claim 16.

25. A poly(aryl ether sulfone) polymer, (t-PAES) polymer, comprising recurring units (Rₜ) of formula (Sₜ):
-E-Ar¹—SO₂—[Ar²-(T-Ar³)ₙSO₂]ₘ—Ar⁴— (Sₜ)
wherein:
n and m, equal to or different from each other, are independently zero or an integer ranging from 1 to 5;
each of Ar¹, Ar², Ar³ and Ar⁴, equal to or different from each other, is an aromatic moiety;
T is a bond or a divalent group optionally comprising one or more than one heteroatom;
E is a group of formula (Eₜ): 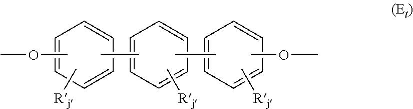
wherein:
each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
j′ is zero or is an integer ranging from 1 to 4, and
further wherein the (t-PAES) polymer exhibits a ¹H NMR signal at from about 8.1 ppm to about 8.3 ppm of ≤1.

26. The (t-PAES) polymer of claim 25, wherein said recurring units (Rₜ) are selected from recurring units of formula (Sₜ-1) to (Sₜ-4): 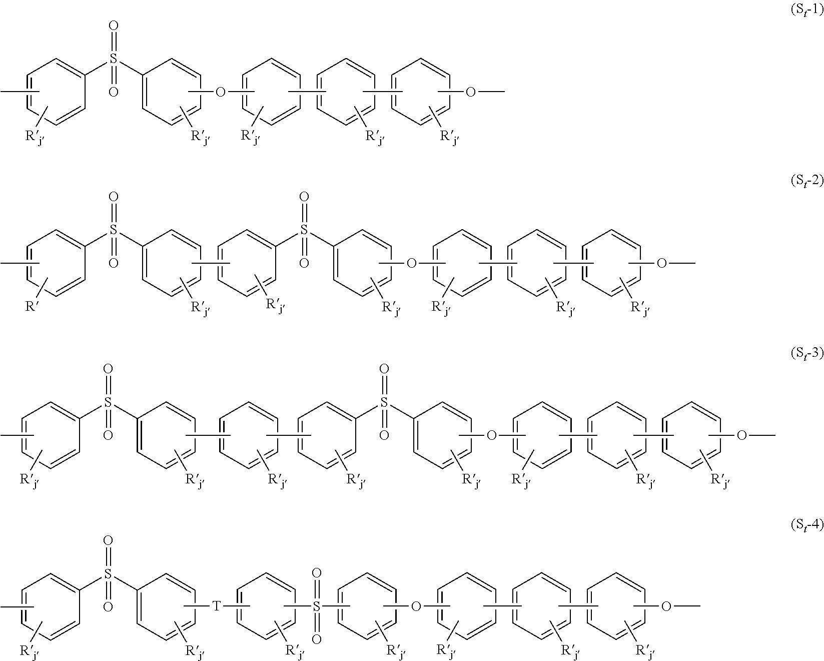
wherein:
each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;
j′ is zero or an integer ranging from 1 to 4;
T is selected from a bond, —CH₂—, —C(O)—, —C(CH₃)₂—, —C(CF₃)₂—, —C(═CCl₂)—, —C(CH₃)(CH₂CH₂COOH)—, and a group of formula:

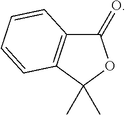

27. The (t-PAES) polymer of claim 25 further comprising recurring units (Rₐ) of formula (Kₐ):
-E-Ar⁵—CO—[Ar⁶-(T-Ar⁷)ₙ—CO]ₘ—Ar⁸— (Kₐ)
wherein:
n and m, equal to or different from each other, are independently zero or an integer ranging from 1 to 5;
each of Ar⁵, Ar⁶, Ar⁷ and Ar⁸ equal to or different from each other, is an aromatic moiety;
T is selected from a bond, —CH₂—, —C(O)—, —C(CH₃)₂—, —C(CF₃)₂—, —C(═CCl₂)—, —C(CH₃)(CH₂CH₂COOH)—, and a group of formula: 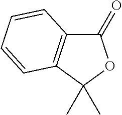
E is of formula (Eₜ): 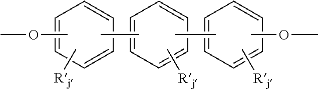
wherein:
each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium.

28. The (t-PAES) polymer of claim 25 further comprising recurring units (R_{b}) of formula (S1):
—Ar⁹-(T′-Ar¹⁰)ₙ—O—Ar¹¹—SO₂—[Ar¹²-(T-Ar¹³)ₙ—SO₂]ₘ—Ar¹⁴—O— (S1)
wherein:
Ar⁹, Ar¹⁰, Ar¹¹, Ar¹², Ar¹³ and Ar¹⁴, equal to or different from each other, are independently an aromatic mono- or polynuclear group;
T and T′, equal to or different from each other, are independently selected from a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula: 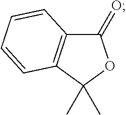
and
n and m, equal to or different from each other, are independently zero or an integer ranging from 1 to 5.

29. The (t-PAES) polymer of claim 25 further comprising recurring units (R_{c}) selected from: 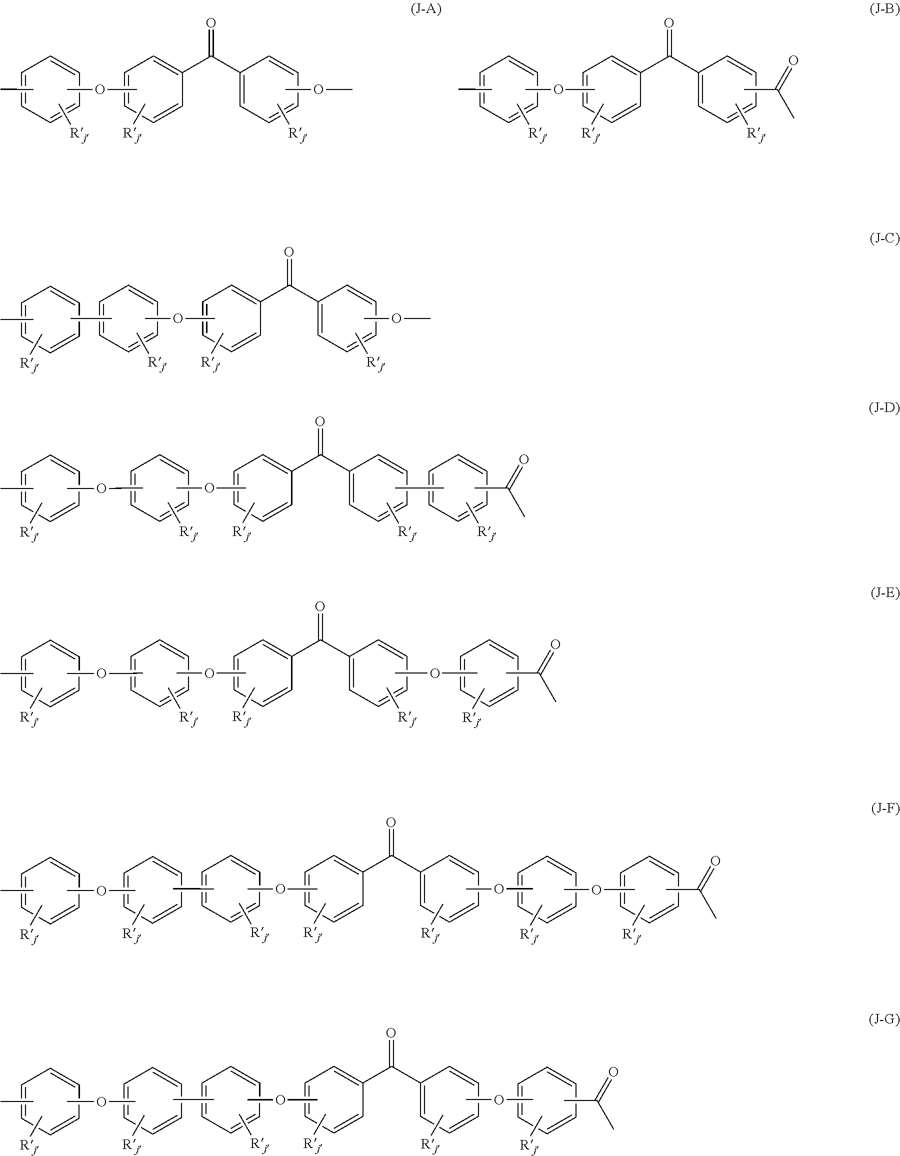 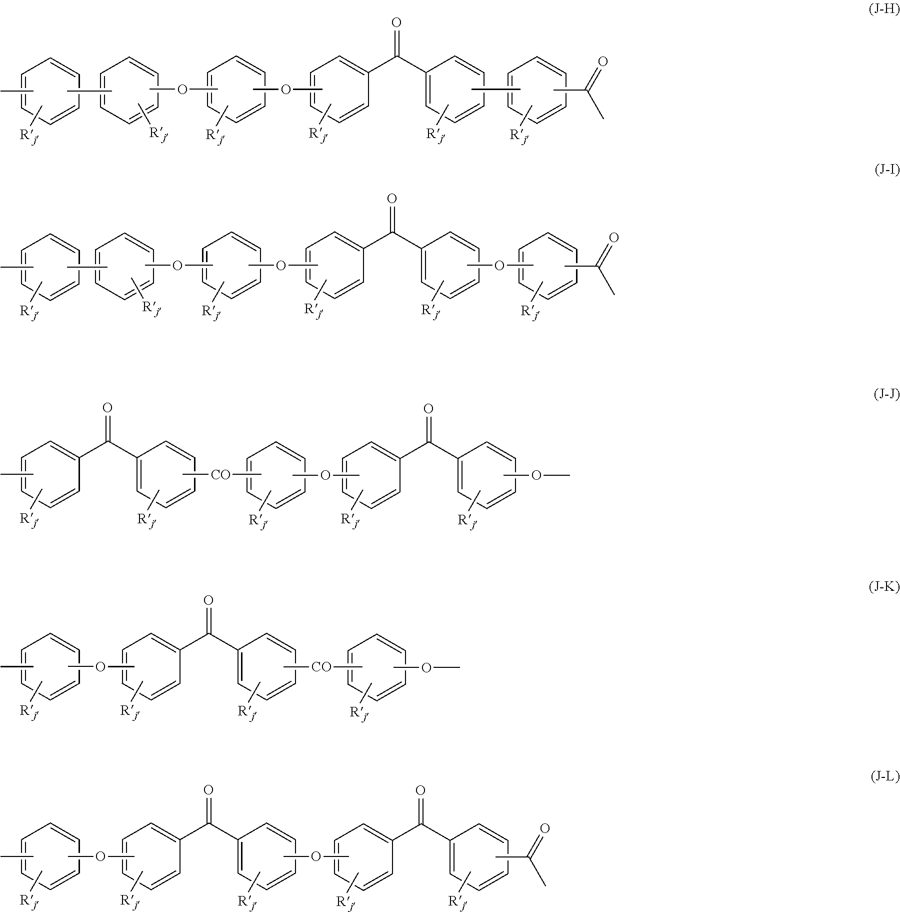
wherein:
each of R′, equal to or different from each other, is selected from a halogen, an alkyl, an alkenyl, an alkynyl, an aryl, an ether, a thioether, a carboxylic an acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and
j′ is zero or is an integer from 0 to 4.

30. A shaped article comprising the (t-PAES) polymer of claim 25.

31. The poly(aryl ether sulfone) polymer, (t-PAES) polymer, of claim 25, wherein T is selected from a bond, —CH₂—, —C(O)—, —C(CH₃)₂—, —C(CF₃)₂—, —C(═CCl₂)—, —C(CH₃)(CH₂CH₂COOH)—, and a group of formula: [chemical structure]
